(19) United States
(12) Patent Application Publication
(10) Pub. No.: US 2024/0135156 A1
(43) Pub. Date: Apr. 25, 2024

(54) NEURAL PROCESSING UNIT CAPABLE OF PROCESSING BILINEAR INTERPOLATION

(71) Applicant: DEEPX CO., LTD., Seongnam-si (KR)

(72) Inventors: HyungSuk KIM, Seongnam-si (KR); JungBoo PARK, Seoul (KR)

(73) Assignee: DEEPX CO., LTD., Seongnam-si (KR)

(21) Appl. No.: 18/380,149

(22) Filed: Oct. 13, 2023

(30) Foreign Application Priority Data
Oct. 14, 2022 (KR) 10-2022-0132624
Sep. 6, 2023 (KR) 10-2023-0118599

(51) Int. Cl. G06N 3/063; G06N 3/0464; G06N 3/096

(52) U.S. Cl. CPC G06N 3/063; G06N 3/0464; G06N 3/096

(57) ABSTRACT

A neural processing unit is provided. The neural processing unit may include a plurality of processing elements configured to perform bilinear interpolation to generate second data by expanding resolution of first data. The first data may include first pixel data, and the second data may include second pixel data. The plurality of processing elements may include at least one processing element configured to receive the first pixel data and a weight for performing the bilinear interpolation and to calculate the second pixel data. The plurality of processing elements may be configured as a processing element array that may include at least one delay buffer.

### CROSS-REFERENCE TO RELATED APPLICATIONS

This application claims the priority of Korean Patent Application No. 10-2023-0118599 filed on Sep. 9, 2023, and No. 10-2022-0132624 filed on Oct. 14, 2022, in the Korean Intellectual Property Office, the disclosure of which is incorporated herein by reference.

### BACKGROUND OF THE DISCLOSURE

### Technical Field

The present disclosure relates to a neural processing unit (NPU) that is capable of processing bilinear interpolation and to a method of operating the same.

### Background Art

Humans are equipped with intelligence capable of recognition, classification, inference, prediction, control/decision making, and the like. Artificial intelligence (AI) refers to the artificial imitation of human intelligence.

The human brain is made up of numerous nerve cells called neurons. Each neuron is connected to hundreds to thousands of other neurons through connections called synapses. The modeling of the operating principle of biological neurons and the connection relationship between neurons in order to imitate human intelligence is called an artificial neural network (ANN) model. In other words, an artificial neural network (ANN) is a system in which nodes that imitate neurons are connected in a layer structure.

These artificial neural network models are divided into “single-layer neural network” and “multi-layer neural network” according to the number of layers. A general multi-layer neural network consists of an input layer, a hidden layer, and an output layer. The input layer is a layer that receives external data, and the number of neurons in the input layer is the same as the number of input variables. The hidden layer is located between the input layer and the output layer, receives a signal from the input layer, extracts characteristics, and transmits it to the output layer. The output layer receives a signal from the hidden layer and outputs it to the outside. The input signal between neurons is multiplied by each connection strength with a value between zero and one and is then summed. If this sum is greater than the neuron threshold, the neuron is activated and implemented as an output value through the activation function.

Meanwhile, a network in which the number of hidden layers of an artificial neural network is increased in order to implement higher artificial intelligence is called a deep neural network (DNN).

There are several types of DNNs, but convolutional neural networks (CNNs) are known to be superior to extract features from input data and identify patterns of features.

A convolutional neural network refers to a network structure in which operations between neurons of each layer are implemented by convolution of a matrix-type input signal and a matrix-type weight kernel.

Convolutional neural networks are neural networks that function similar to image processing in the visual cortex of the human brain. Convolutional neural networks are known to be suitable for image classification and object detection.

Convolutional neural networks are also known to be suitable for image segmentation. Image segmentation operations require interpolation operations. Meanwhile, the amount of computation required for segmentation processing tends to be larger than that for image classification and object detection.

Referring to FIG. 3, the convolutional neural network is configured in a form in which convolutional channels and pooling channels are alternatively repeated. In a convolutional neural network, most of the computation time is occupied by the operation of convolution.

A convolutional neural network inferences objects by extracting image features of each channel by a matrix-type kernel, and providing homeostasis such as movement or distortion by pooling. For each channel, a feature map is obtained by convolution of the input data and the kernel, and an activation is applied to generate an activation map of the corresponding channel. Pooling may then be applied.

The neural network that actually classifies the pattern may be located at the end of the feature extraction neural network, and is called a fully-connected layer. In the computational processing of convolutional neural networks, most computations are performed through convolution or matrix multiplication.

Meanwhile, to improve the resolution of input data, bilinear interpolation may be performed. The operation according to this bilinear interpolation method may be expressed as a convolution operation between the pixel data of the input data and a predetermined kernel.

Accordingly, in order to improve the resolution of the input data using bilinear interpolation, the convolution operation of the pixel data of the input data and a plurality of predetermined kernels may be repeated.

At this time, the frequency of reading the necessary weight kernels from memory is high. A significant portion of the operation of the convolutional neural network takes time to read the weight kernels corresponding to each channel from the memory.

The memory may be divided into main memory, internal memory, and on-chip memory. Each memory consists of a plurality of memory cells, and each memory cell of the memory has a unique memory address. When the neural processing unit reads a weight or a parameter stored in the main memory, a latency of several clock cycles may occur until the memory cell corresponding to the address of the main memory is accessed. This delay time may include Column Address Strobe (CAS) latency and Row Address Strobe (RAS) latency.

Artificial neural network calculations require massive amounts of data. Therefore, there is a problem in that a significant amount of time and power consumption is required to read the necessary data, i.e., parameters, such as weights, feature maps or kernels, from the main memory to the neural processing unit.

### SUMMARY OF THE DISCLOSURE

The inventors of the present disclosure have recognized that, during inference of the artificial neural network model, the neural processing unit (NPU) frequently reads the feature map or weight kernel of a specific layer of the artificial neural network model from the main memory.

The inventors of the present disclosure have recognized that, the reading operations of the feature map or kernel of the artificial neural network model from the main memory to NPU is slow and consumes a lot of energy.

The inventors of the present disclosure have recognized that more access to on-chip memory or NPU internal memory, rather than access to main memory, can increase processing speed and reduce energy consumption.

Additionally, the NPU may be designed to include a large number of processing elements. The inventors of the present disclosure also recognized that if bilinear interpolation is processed using a plurality of processing elements, bilinear interpolation may be processed quickly through parallel processing.

Accordingly, the present disclosure discloses a neural processing unit and a method of operating the same that can reduce the number of main memory read operations and reduce power consumption by reusing weights when performing convolution calculations to apply bilinear interpolation in the NPU.

Accordingly, the present disclosure discloses a neural processing unit configured to perform bilinear interpolation in a plurality of processing elements of an NPU and a method of operating the same.

However, the present disclosure is not limited thereto, and other aspects will be clearly understood by those skilled in the art from the following description.

In order to solve the problems described above, a neural processing unit according to an example of the present disclosure is provided.

According to an aspect of the present disclosure, there is provided a neural processing unit or NPU. The NPU may include a plurality of processing elements (PEs) configured to perform bilinear interpolation to generate second data by expanding resolution of first data. The first data may include first pixel data, and the second data may include second pixel data.

The plurality of PEs may include at least one PE configured to receive the first pixel data and a weight for performing the bilinear interpolation and to calculate the second pixel data.

The plurality of PEs may include at least one PE configured to receive a 2×2 weight for the bilinear interpolation.

The plurality of PEs may be further configured such that a weight is inputted to each PE of the plurality of PEs. The weight may be a coefficient that is multiplied by the first pixel data to perform the bilinear interpolation.

The second data may include at least one pixel positioned between a plurality of adjacent pixels of the first data.

The plurality of PEs may include at least one PE configured to duplicate a pixel of the first pixel data corresponding to an outermost area of the first data to be copied to an outer area of the first data. The duplication by the at least one processing element may generate a pixel of the second pixel data corresponding to an outermost area of the second data.

The neural processing unit may further include a floating-point multiplier connected to an output of the plurality of PEs and configured to perform decimal operations.

The plurality of PEs may be further configured to perform a depth-wise convolution.

The plurality of PEs may include a PE array arranged in rows and columns. The PE array includes a delay buffer that delays a weight for performing the bilinear interpolation by a number of clock cycles and transmits the weight to an adjacent PE of the PE array.

The plurality of PEs may include a PE array arranged in rows and columns, the PE array including at least one delay buffer. The PE array may be configured such that a weight for performing the bilinear interpolation is broadcast to PEs of a specific row of the PE array and to a corresponding delay buffer of the at least one delay buffer.

The plurality of PEs may include a PE array arranged in plural rows and plural columns, and a delay buffer corresponding to adjacent rows of the PE array, the delay buffer being disposed between the adjacent rows. The delay buffer may be configured to reuse weights by transferring, in a next clock cycle, a weight input to a PE of a first row of the plural rows to a PE of a second row of the plural rows.

The plurality of PEs may be further configured to perform a point-wise convolution.

The plurality of PEs may include a PE array arranged in rows and columns. The bilinear interpolation may be performed using a plurality of weights, each weight of the plurality of weights being broadcast to a different row of the PE array.

The plurality of PEs may include a PE array arranged in rows and columns, and a plurality of delay buffers connected in series to delay and output the first pixel data to a specific clock cycle.

The plurality of PEs may include a PE array arranged in plural rows and plural columns, the PE array including a plurality of delay buffers. The first pixel data may be broadcast to PEs of a first row of the plural rows and to the plurality of delay buffers.

The plurality of PEs may include a PE array that includes a delay buffer. The first pixel data may be inputted to a PE of a row of the PE array and may be delayed by the delay buffer. The delayed first pixel data may be reused in another PE of a next row of the PE array.

The first data may be input data of a specific layer of an artificial neural network model. The second data may be output data of the specific layer. The second data may be a result of applying the bilinear interpolation to the first data by applying a weight for performing the bilinear interpolation in a specific PE of the plurality of PEs.

The first data may be one of an image, a feature map, and an activation map. The first data may be input data of a specific layer of an artificial neural network model to which the bilinear interpolation is applied. The second data may be output data of the specific layer.

The plurality of PEs may include a multiplier, an adder, and an accumulator.

The plurality of PEs may be further configured such that the bilinear interpolation performs an upscaling operation or segmentation operation of an artificial neural network model to which the bilinear interpolation is applied.

Effects according to the disclosure are not limited by those exemplified above, and more various effects are included in the present disclosure.

According to the present disclosure, the number of main memory read operations may be reduced and power consumption may be reduced by reusing weights and pixel data when performing convolution calculations for bilinear interpolation in the NPU.

In addition, according to the present disclosure, it is possible to provide a neural processing unit that saves energy used in the NPU and improves the efficiency and utilization rate of the processing element array by delaying and reusing weights and pixel data when performing convolution calculations to apply bilinear interpolation.

In addition, according to the present disclosure, a plurality of processing elements may be utilized for a bilinear interpolation operation to provide a neural processing unit capable of processing the bilinear interpolation operation in parallel at high speed.

### BRIEF DESCRIPTION OF THE DRAWINGS

FIG. 1 is a schematic diagram illustrating a device including a neural processing unit according to an example of the present disclosure.

FIG. 2 is a schematic diagram explaining a compiler related to the present disclosure.

FIG. 3 is a schematic diagram explaining a convolutional neural network related to the present disclosure.

FIG. 4 is a schematic diagram explaining a neural processing unit according to an example of the present disclosure.

FIG. 5 is a schematic diagram explaining bilinear interpolation applicable to the present disclosure.

FIG. 6 is a schematic diagram illustrating a method of sorting second data applicable to the present disclosure.

FIG. 7 is a diagram illustrating a method of generating data of a first pixel of second data by applying bilinear interpolation in the present disclosure.

FIG. 8 is a diagram illustrating a method of generating data of a second pixel of second data by applying bilinear interpolation in the present disclosure.

FIG. 9 is a diagram illustrating a method of generating data of a third pixel of second data by applying bilinear interpolation in the present disclosure.

FIG. 10 is a diagram illustrating a method of generating dara of a fourth pixel of second data by applying bilinear interpolation in the present disclosure.

FIG. 11 is a schematic diagram illustrating a method of externally copying first data applicable to the present disclosure.

FIG. 12 is a schematic diagram illustrating one processing element among the processing element array applicable to the present disclosure.

FIG. 13 is a configuration diagram illustrating one processing element among the processing element array according to an example of the present disclosure.

FIG. 14 is a diagram illustrating input data and output data applied to a processing element array according to an example of the present disclosure.

FIG. 15 is a diagram illustrating an arrangement relationship between input data and output data applied to a processing element array according to an example of the present disclosure.

FIG. 16 is a schematic diagram illustrating the structure of a processing element array according to an example of the present disclosure.

FIGS. 17 to 27 are diagrams for explaining how a processing element array according to an example of the present disclosure operates during a plurality of clock cycles.

FIG. 28 is a schematic diagram illustrating the structure of a processing element array according to another example of the present disclosure.

FIGS. 29 to 36 are diagrams for explaining how a processing element array according to an example of the present disclosure operates during a plurality of clock cycles.

### DETAILED DESCRIPTION OF THE EMBODIMENT

Particular structural or step-by-step descriptions for examples according to the concept of the present disclosure disclosed in the present disclosure or application are merely exemplified for the purpose of explaining the examples according to the concept of the present disclosure. Examples according to the concept of the present disclosure may be embodied in various forms, and examples according to the concept of the present disclosure may be embodied in various forms, and should not be construed as being limited to the examples described in the present disclosure or application.

Since the examples according to the concept of the present disclosure may have various modifications and may have various forms. Accordingly, specific examples will be illustrated in the drawings and described in detail in the present disclosure or application. However, this is not intended to limit the examples according to the concept of the present disclosure with respect to the specific disclosure form, and should be understood to include all modifications, equivalents, and substitutes included in the spirit and scope of the present disclosure.

Terms such as first and/or second may be used to describe various elements, but the elements should not be limited by the terms. The above terms are only for the purpose of distinguishing one element from another element, for example, without departing from the scope according to the concept of the present disclosure, and a first element may be termed a second element, and similarly, a second element may also be termed a first element.

When an element is referred to as being “connected to” or “in contact with” another element, it is understood that the other element may be directly connected to or in contact with the other element, but other elements may be disposed therebetween. On the other hand, when it is mentioned that a certain element is “directly connected to” or “directly connected” another element, it should be understood that no other element is present therebetween. Other expressions describing the relationship between elements, such as “between” and “directly between” or “adjacent to” and “directly adjacent to” should be interpreted similarly.

In this disclosure, expressions such as “A or B,” “at least one of A or/and B,” or “one or more of A or/and B” may include all possible combinations of the items listed together. For example, “A or B,” “at least one of A and B,” or “at least one of A or B” may refer to all instances of (1) including at least one A, (2) including at least one B, or (3) including both at least one A and at least one B.

As used herein, expressions such as “first,” “second,” or “first or second” may modify various elements, regardless of order and/or importance. The expressions are used only to distinguish one element from other elements and do not limit the elements. For example, the first user apparatus and the second user apparatus may represent a different user apparatus regardless of order or importance. For example, without departing from the scope of the claims described in this disclosure, the first element may be named as the second element, and similarly, the second element may also be renamed as the first element.

Terms used in the present disclosure are used only describe specific examples, and are not be intended to limit the scope of other examples. The singular expression may include the plural expression unless the context clearly dictates otherwise. Terms used herein, including technical or scientific terms, may have the same meanings as commonly understood by one having ordinary skill in the art described in this disclosure.

Among the terms used in the present disclosure, terms defined in a general dictionary may be interpreted as having the same or similar meaning as the meaning in the context of the related art, and unless explicitly defined herein, it should not be construed in an idealistic or overly formal sense. In some cases, even terms defined in the present disclosure should not be construed to exclude examples of the present disclosure.

It should be understood that terms such as “comprise” or “having” are intended to indicate that the described feature, number, step, operation, element, part, or combination thereof exists, and it does not preclude the possibility of the presence or addition of one or more other features, numbers, steps, operations, elements, parts, or combinations thereof.

Each of the features of the various examples of the present disclosure may be partially or wholly combined or combined with each other. In addition, as those skilled in the art can fully understand, various interlocking and driving operations are possible, and each example may be implemented independently of each other or may be implemented together in a related relationship.

In describing the examples, descriptions of technical content that are well known in the technical field to which the present disclosure pertains and are not directly related to the present disclosure will be omitted. This is to more clearly convey the core of the present disclosure without obscuring it by omitting unnecessary description.

### Definition of Terms

Hereinafter, in order to facilitate understanding of the disclosures presented in the present disclosure, terms used in the present disclosure will be briefly summarized.

NPU: An abbreviation of neural processing unit. It may refer to a specialized processor for computation of an artificial neural network model, separately from a central processing unit (CPU).

ANN: An abbreviation of artificial neural network. It may refer to a network in which nodes are connected in a layer structure by mimicking those neurons in the human brain are connected through synapse in order to imitate human intelligence.

Artificial neural network information: This information may include network structure information, information on the number of layers, connection relationship information of each layer, weight information of each layer, information on calculation processing methods, activation function information, and the like.

DNN: An abbreviation of deep neural network. It may refer to the number of hidden layers of the artificial neural network being increased in order to implement higher artificial intelligence.

CNN: An abbreviation for convolutional neural network, which is a neural network that functions similarly to image processing in the visual cortex of the human brain. Convolutional neural networks are known to be suitable for image processing, and are known to be superior to extract features from input data and identify patterns of features.

Kernel: The weight value of an N×M matrix for convolution. Each layer of the artificial neural network model has a plurality of kernels, and the number of kernels may be referred to as the number of channels or the number of filters.

Transformer: A transformer is a DNN based on attention technology. Transformers utilize many matrix multiplication operations. The transformer can obtain attention (Q, K, V), which is an output value, using input values and parameters such as query (Q), key (K), and value (V). Transformers can process various inference operations based on output values (i.e., attention (Q, K, V)). Transformers tend to show better inference performance than CNNs.

Hereinafter, examples of the present disclosure will be described with reference to the accompanying drawings.

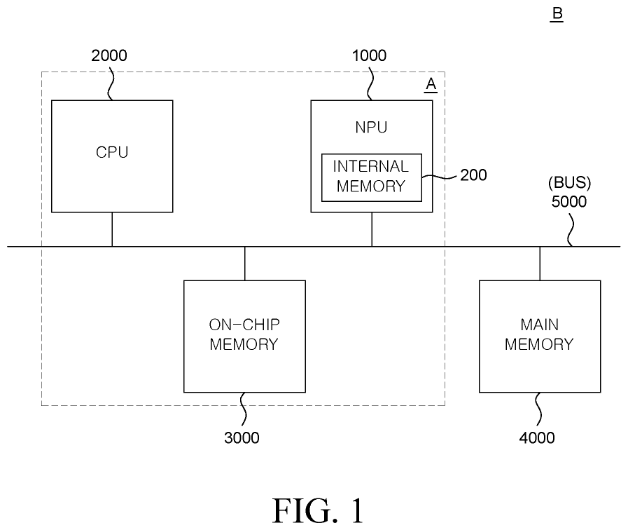

FIG. 1 illustrates an apparatus including a neural processing unit according to an example of the present disclosure.

Referring to FIG. 1, a device B including a neural processing unit 1000 includes an on-chip region A.

A main memory 4000 may be included outside the on-chip area.

For example, the main memory 4000 may include one of memories such as ROM, SRAM, DRAM, resistive RAM, magneto-resistive RAM, phase-change RAM, ferroelectric RAM, flash-memory, and high bandwidth memory (HBM). The main memory 400 may be configured with at least one memory unit. The main memory 4000 may be configured as a homogeneous memory unit or a heterogeneous memory unit. The memory may be composed of a plurality of logic gate circuits. Accordingly, memory circuits may be difficult to identify and distinguish with the naked eye, but may be identified through operation.

The neural processing unit (NPU) 1000 is a processor specialized to perform an operation for an artificial neural network.

The neural processing unit 1000 is disposed in the on-chip area A. The neural processing unit 1000 may include an internal memory 200. The internal memory 200 may include a volatile memory and/or a non-volatile memory.

For example, the internal memory 200 may include one of memories such as ROM, SRAM, DRAM, resistive RAM, magneto-resistive RAM, phase-change RAM, ferroelectric RAM, flash memory, and HBM. The internal memory 200 may include at least one memory unit. The internal memory 200 may be configured as a homogeneous memory unit or a heterogeneous memory unit.

An on-chip memory 3000 may be disposed in the on-chip area A. The on-chip memory 3000 may be a memory mounted on a semiconductor die and may be a memory for caching or storing data processed in the on-chip area A. The on-chip memory 3000 may include one of memories such as ROM, SRAM, DRAM, resistive RAM, magneto-resistive RAM, phase-change RAM, ferroelectric RAM, flash memory, and HBM. The on-chip memory 3000 may include at least one memory unit. The on-chip memory 3000 may be configured as a homogeneous memory unit or a heterogeneous memory unit.

A general-purpose processing unit such as a central processing unit (CPU) 2000 may be disposed in the on-chip area A. The CPU 2000 may be operatively connected to the neural processing unit 1000, the on-chip memory 3000, and the main memory 4000.

The device B including the neural processing unit 1000 may include at least one of the internal memory 200, the on-chip memory 3000, and the main memory 4000 of the aforementioned neural processing unit 1000. However, the present disclosure is not limited thereto.

Hereinafter, the at least one memory unit is intended to include at least one of the internal memory 200, the on-chip memory 3000, and the main memory 4000. Also, the description of the on-chip memory 3000 is intended to include the internal memory 200 of the neural processing unit 1000 or a memory external to the neural processing unit 1000 but in the on-chip area A.

The neural processing unit 1000 may be a semiconductor implemented as an electrical/electronic circuits. The electrical/electronic circuits may mean including numerous electronic elements (e.g., transistors and capacitors). The neural processing unit 1000 may include a processing element array, internal memory 200, a controller, a special function unit, and an interface. Each of the processing element array, internal memory 200, controller, special function unit, and interface may be a semiconductor circuit to which numerous transistors are connected. A semiconductor circuit may be a circuit consisting of a plurality of logic gates. Therefore, some of the circuits may be difficult to identify and distinguish with the naked eye, and can only be identified through operation thereof. For example, an arbitrary circuit may operate as a processing element array, or it may operate as a controller.

The neural processing unit 1000 may include a processing element array, an internal memory 200 configured to store at least a portion of an artificial neural network model that may be inferred from the processing element array, and a scheduler configured to control the processing element array and the internal memory 200 based on information about the data locality or structure of the artificial neural network model. Here, the artificial neural network model may include information about data locality or structure of the artificial neural network model. However, the present disclosure is not limited thereto. An artificial neural network model may refer to an AI recognition model trained to perform a specific inference function.

In the case of a transformer and/or CNN-based artificial neural network model, the neural processing unit 1000 can select and process matrix multiplication operations, convolution operations, and the like according to the architecture of the artificial neural network model.

For example, in each layer of a convolutional neural network (CNN), the input feature map corresponding to the input data and the kernel corresponding to the weight may be a matrix composed of a plurality of channels. A convolution operation of the input feature map and the kernel is performed, and an output feature map is generated as a result of the convolution operation in each channel. An activation map for the corresponding channel is created by applying an activation function to the output feature map. Afterwards, pooling on the activation map may be applied. Here, the activation map may be generically referred to as the output feature map. Weights, activation functions, input feature maps, activation maps, and output feature maps can also be referred to as parameters of the artificial neural network model.

For example, an artificial neural network model may be a model configured to learn to perform inference such as object detection, object segmentation, image/video reconstruction, image/video enhancement, object tracking, event recognition, event prediction, anomaly detection, density estimation, event search, measurement, and the like.

For example, the artificial neural network model may be a model such as ViT, DaViT, MobileViT, Swin-Transformer, Transformer, RCNN, SegNet, DeconvNet, DeepLAB, U-net, PIDNet, Segment Anything, Segment Anything Model (SAM), MobileSAM, Bisenet, Shelfnet, Alexnet, Densenet, Efficientnet, EfficientDet, Googlenet, Mnasnet, Mobilenet, Resnet, Shufflenet, Squeezenet, VGG, Yolo, RNN, CNN, DBN, RBM, LSTM. However, the present disclosure is not limited thereto, and new artificial neural network models to be operated on NPU are continuously being announced.

An exemplary artificial neural network model may be configured to include a multi-layer structure. For example, the MobileNet V1.0 model may have 28 layers.

An artificial neural network refers to a network composed of artificial neurons that, when an input signal is received, applies a weight to the input signal and selectively applies an activation function. Such an artificial neural network may be used to output inference results from input data.

The processing element array may perform operations for the artificial neural network. For example, when input data is input, the processing element array may perform training of the artificial neural network. Also, when input data is input, the processing element array may perform an operation of deriving an inference result through the trained artificial neural network model.

For example, the neural processing unit 1000 may call at least a portion of the data of the artificial neural network model stored in the main memory 4000 to the internal memory 200 through the interface.

The controller may be configured to control an operation on processing element array for an inference processing and control the read and write sequence of the internal memory 200. Further, the controller may be configured to resize at least a portion of a batch of channels corresponding to the input data. The controller may be comprised of a plurality of logic gate circuits. Accordingly, the controller may be difficult to identify and distinguish with the naked eye, and may be identified through operation thereof.

According to the structure of the artificial neural network model, calculations for each layer may be sequentially performed. That is, when the structure of the artificial neural network model is determined, the operation sequence for each layer may be determined. Depending on the size of the internal memory 200 or the on-chip memory 3000 of the neural processing unit 1000, the operation for each layer may not be processed at once. In this case, the neural processing unit 1000 may divide one operation processing step into a plurality of operation processing steps by tiling the corresponding layer to an appropriate size. The structure of the artificial neural network model and the sequence of operation or data flow according to the hardware constraint of the neural processing unit 1000 may be defined as data locality of the artificial neural network model inferred from the neural processing unit 1000.

That is, when the compiler compiles the artificial neural network model so that the artificial neural network model is executed in the neural processing unit 1000, the artificial neural network data locality of the artificial neural network model at the NPU-memory level may be reconstructed. For example, the compiler may be executed by the CPU 2000. Alternatively, the compiler may run on a separate machine. Compilers may be implemented as software or firmware.

That is, according to the compiler, the algorithms applied to the artificial neural network model, the operating characteristics of the neural processing unit 1000, the size of weight values, and the number of feature maps or channels, the size and sequence of data required for processing the artificial neural network model loaded into the internal memory 200 may be determined.

For example, even in case of the same artificial neural network model, the calculation method of the artificial neural network model to be processed may be configured differently according to the method and the characteristics in which the neural processing unit 1000 calculates the corresponding artificial neural network model, for example, feature map tiling method, stationary method of processing elements and the like, the number of processing elements of the neural processing unit 1000, the size of the feature map and the size of the weight in the neural processing unit 1000, the internal memory capacity, the memory hierarchy of the neural processing unit 1000, and algorithmic characteristic of the compiler that determines the sequence of operations of the neural processing unit 1000 for processing the artificial neural network model. This is because, even if the same artificial neural network model is processed by the above-mentioned factors, the neural processing unit 1000 may differently determine the sequence of data required at each moment in each clock cycle.

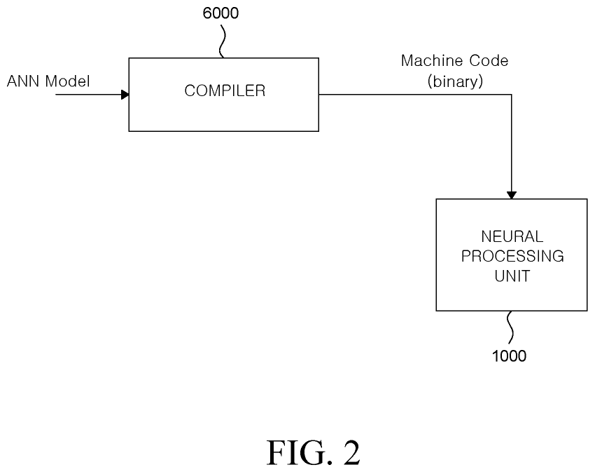

Hereinafter, the compiler will be described with reference to FIG. 2.

FIG. 2 illustrates a compiler related to the present disclosure.

Referring to FIG. 2, the compiler 500 has a frontend and a backend, and an intermediate representation (IR) used for program optimization is present between the frontend and the backend. For example, the compiler 5000 may be configured to receive an artificial neural network model generated by a deep learning framework provided by ONNX, TensorFlow, PyTorch, mxnet, Keras, and the like.

The frontend may perform hardware-independent transformation and optimization on the input artificial neural network model, and the IR is used to represent the source code. The backend may generate machine code in binary form (i.e., code that may be used in the neural processing unit 1000) from the source code.

Since the compiler 6000 schedules the processing order based on the data locality of the artificial neural network model, it may operate differently from the scheduling concept of a general CPU. Typical, CPU scheduling takes into account fairness, efficiency, stability, response time, and the like and operates to achieve the best efficiency. In other words, scheduling of the CPU is performed to perform the most processing within the same amount of time, taking into account priority, computation time, and the like. In other words, the conventional CPU uses an algorithm to schedule tasks by considering data such as priority order of each processing and operation processing time.

In contrast, the compiler 6000 may control the neural processing unit 1000 in the processing order of the neural processing unit 1000 determined based on data locality information or information on the structure of the artificial neural network model.

That is, the neural processing unit 1000 may be configured to operate based on machine code compiled from the compiler 6000, but in another example, the neural processing unit 1000 may be configured to have an embedded compiler. According to the above-described configuration, the neural processing unit 1000 may be configured to receive a file in the framework format of various AI software and generate machine code. In another example, the device B including the neural processing unit 1000 may be configured to include an embedded compiler.

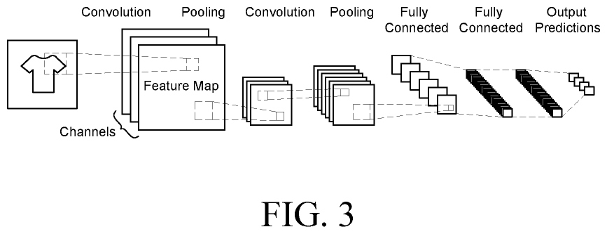

Hereinafter, a convolutional neural network (CNN), which is a type of a deep neural network (DNN) among a plurality of ANNs, will be described with reference to FIG. 3.

FIG. 3 illustrates a convolutional neural network according to the present disclosure.

The CNN may be a combination of one or several convolutional layers, a pooling layer, and a fully-connected layer. The CNN has a structure suitable for learning and inferencing of two-dimensional data, and may be trained through a backpropagation algorithm.

In the example of the present disclosure, in the CNN, there is a kernel (i.e., a weight kernel) for extracting features of an input image of a channel for each channel. The kernel may be composed of a two-dimensional matrix, and convolution operation is performed while traversing input data. The size of the kernel may be arbitrarily determined, and the stride at which the kernel traverses input data may also be arbitrarily determined. A result of convolution of all input data per kernel may be referred to as a feature map or an activation map.

Hereinafter, the kernel may include a set of weight values or a plurality of sets of weight values. The number of kernels for each layer may be referred to as the number of channels.

As such, since the convolution operation is an operation formed by combining input data and a kernel, an activation function for adding non-linearity may be applied thereafter. When an activation function is applied to a feature map that is a result of a convolution operation, it may be referred to as an activation map.

Specifically, referring to FIG. 3, the CNN may include at least one convolutional layer, at least one pooling layer, and at least one fully-connected layer.

For example, a convolution may be defined by two main parameters that the size of the input data (typically a 1×1, 3×3, or 5×5 matrix) and the depth of the output feature map (the number of kernels). These key parameters may be computed by convolution. These convolutions may start at depth 32, continue to depth 64, and end at depth 128 or 256. The convolution operation may be referred to as an operation of sliding a kernel of size 3×3 or 5×5 over the input image matrix, which is the input data, multiplying each element of the kernel and each element of the input image matrix that overlaps, and then adding them all together.

An activation function may be applied to the output feature map to finally output the activation map. The pooling layer may perform a pooling operation to reduce the size of the feature map by down sampling the output data (i.e., the activation map). For example, the pooling operation may include, but is not limited thereto, max pooling and/or average pooling.

The maximum pooling operation uses the kernel, and outputs the maximum value in the area of the feature map overlapping the kernel by sliding the feature map and the kernel. The average pooling operation outputs the average value within the area of the feature map overlapping the kernel by sliding the feature map and the kernel. As such, since the size of the feature map is reduced by the pooling operation, the number of parameters of the feature map is also reduced.

The fully-connected layer may classify data output through the pooling layer into a plurality of classes (i.e., inferenced values), and may output the classified class and a score thereof. Data output through the pooling layer forms a three-dimensional feature map, and this three-dimensional feature map may be converted into a one-dimensional vector and input as a fully connected layer.

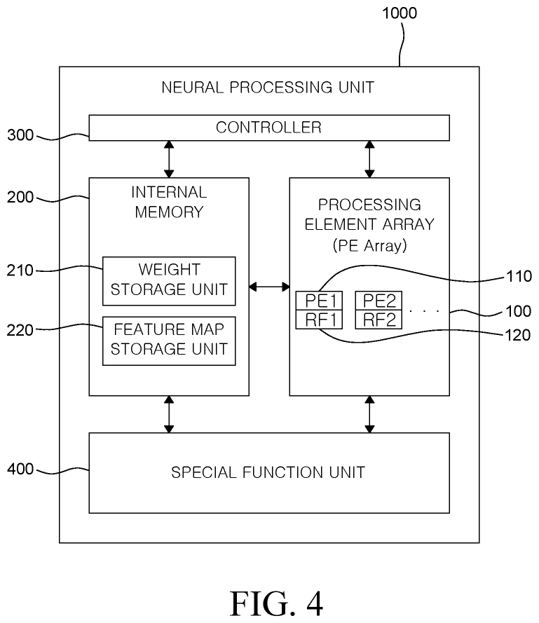

Hereinafter, an NPU will be described with reference to FIG. 4.

FIG. 4 illustrates a neural processing unit according to an example of the present disclosure.

Referring to FIG. 4, a neural processing unit (NPU) 1000 includes a processing element array (PE array) 100, an internal memory 200, a controller 300, and a special function unit (SFU) 400.

The processing element array 100 may be configured to include a plurality of processing elements 110 configured to calculate node data of an ANN and weight data of a connection network. Each processing element may include a multiply-and-accumulate (MAC) operator and/or an arithmetic logic unit (ALU) operator. However, examples according to the present disclosure are not limited thereto. The processing element 110 may be composed of a plurality of logic gate circuits. Accordingly, the processing element 110 may be difficult to identify and distinguish with the naked eye, and may be identified through operation thereof.

In addition, the processing elements 110 as described is an example merely for convenience of explanation, and the number of the plurality of processing elements 110 is not limited. The size or number of the processing element array 100 may be determined by the number of the plurality of processing elements 110. The size of the processing element array may be implemented in the form of an N×M matrix. where N and M are integers greater than zero. Accordingly, the processing element array 100 may include N×M processing elements.

The size of the processing element array 100 may be designed in consideration of the characteristics of the artificial neural network model in which the neural processing unit 1000 operates. In other words, the number of processing elements may be determined in consideration of a data size of an artificial neural network model to be operated, a required amount of computation, and required power consumption. The data size of the artificial neural network model may be determined in correspondence with the number of layers of the artificial neural network model and the weight data size of each layer.

Accordingly, the size of the processing element array 100 according to an example of the present disclosure is not limited. As the number of processing elements 110 of the processing element array 100 increases, the parallel computing power of the processing artificial neural network model may increase, but the manufacturing cost of the neural processing unit 1000 and the physical chip size may also increase.

At least one processing element array 100 may be provided. That is, the processing element array 100 may be configured as plural arrays. When a plurality of processing element arrays 100 is provided, each array may be referred to as an NPU thread, NPU core, or NPU engine.

For example, the artificial neural network model operated in the neural processing unit 1000 may be an ANN trained to detect thirty specific keywords, that is, an AI keyword recognition model. In this case, the size of the processing element array 100 be designed to be 4×3 in consideration of the computational amount characteristic. In other words, the processing element array 100 may be configured to include twelve processing elements. However, it is not limited thereto, and the number of the plurality of processing elements 110 may be selected within a range of, for example, 8 to 16,384. That is, examples of the present disclosure are not limited in the number of processing elements.

The processing element array 100 may be configured to perform functions such as addition, multiplication, and accumulation required for ANN operation. In other words, the processing element array 100 may be configured to perform a multiplication-and-accumulation (MAC) operation.

Meanwhile, the processing element array 100 may not only perform calculations of artificial neural network models, but also calculate bilinear interpolation to increase the resolution of input data.

Input data may be an image, feature map, or activation map. Input data may be input parameters of a specific layer of an artificial neural network model.

That is, pixel data of the first data and a weight, which is a kernel for calculating bilinear interpolation, may be provided to at least one processing element 110 included in the processing element array 100. In addition, at least one processing element 110 may perform a convolution operation of the first data and weights for bilinear interpolation to output upscaled pixel data of the second data.

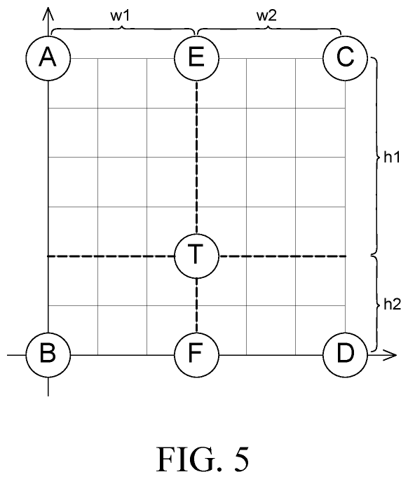

Hereinafter, a method of setting weights used in a bilinear interpolation operation to generate second data by expanding the resolution of the first data will be described with reference to FIGS. 5 to 10.

FIG. 5 is for explaining bilinear interpolation applicable to the present disclosure.

Bilinear interpolation refers to a method of using four-pixel data of first data to calculate pixels of second data, which are respectively disposed between four pixels of the first data. Here, a pixel (or plural pixels) of the first data may be referred to as first pixel data, and a pixel (or plural pixels) of the second data may be referred to as second pixel data.

Here, pixels (or pixel data) may refer to pixels of an image file, pixels of a tensor, pixels of a matrix, pixels of a kernel, pixels of a feature map, pixels of an activation map, and the like.

At this time, pixels of the second data generated by performing bilinear interpolation may be respectively placed between adjacent pixels among a plurality (e.g., four) of pixels of the first data.

Specifically, bilinear interpolation may be calculated by performing linear interpolation on four pixels of the first data. The linear interpolation is first performed based on a first (e.g., horizontal) direction and is then performed based on a second (e.g., vertical) direction.

More specifically, linear interpolation is first performed on two pixels arranged in the horizontal direction among the four pixels of the first data.

For example, as shown in FIG. 5, E pixel data (the data of “E” pixel) may be expressed as w2/(w1+w2)*A+w1/(w1+w2)*C. In addition, F pixel data (the data of “F” pixel) may be expressed as w2/(w1+w2)*B+w1/(w1+w2)*D.

Here, w1 is the horizontal distance between the A pixel and the E pixel or the horizontal distance between the B pixel and the F pixel, and w2 is the horizontal distance between the C pixel and the E pixel or the horizontal distance between the D pixel and the F pixel. Further, A denotes the A pixel data, B denotes the B pixel data, C denotes the C pixel data, and D denotes the D pixel data.

Thereafter, pixel data calculated through linear interpolation in the horizontal direction may be linearly interpolated again in the vertical direction to calculate pixel data of the second data.

That is, by performing linear interpolation on the E pixel data and the F pixel data in the vertical direction, T pixel data, which is pixel data of the second data, may be calculated. The T pixel data may be expressed as h2/(h1+h2)*E+h1/(h1+h2)*F. Here, h1 is the horizontal distance between the E pixel and the T pixel, and h2 is the horizontal distance between the T pixel and the F pixel. Further, E denotes the E pixel data, and F denotes the F pixel data.

If T pixel data is expressed in terms of A pixel data, B pixel data, C pixel data, and D pixel data, it may be expressed as w2/(w1+w2)*h2/(h1+h2)*A+w2/(w1+w2)*h1/(h1+h2)*B+w1/(w1+w2)*h2/(h1+h2)*C+w1/(w1+w2)*h1/(h1+h2)*D.

To summarize, T pixel data may be expressed as W0*A+W1*B+W2*C+W3*D, which is the value obtained by convolution of the input data

$$( \begin{matrix}A & C \\ B & D\end{matrix} )$$

with the kernel

$$( \begin{matrix}W 0 & W 2 \\ W 1 & W 3\end{matrix} ) ,$$

where W0=w2/(w1+w2)*h2/(h1+h2), W1=w2/(w1+w2)*h1/(h1+h2), W2=w1/(w1+w2)*h2/(h1+h2), and W3=w1/(w1+w2)*h1/(h1+h2).

Tha2xt is, each element of the kernel, or weight, may be expressed as a coefficient that is multiplied by the data of a plurality of pixels of the first data to perform bilinear interpolation.

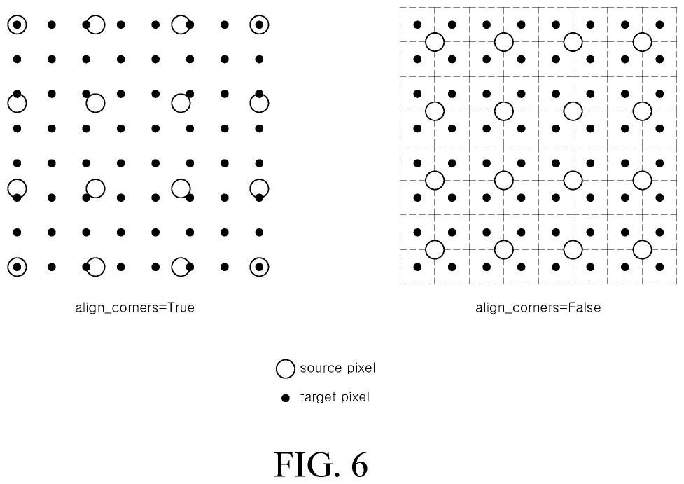

FIG. 6 illustrates a method of sorting second data applicable to the present disclosure.

When generating second data, which is a target image, by increasing the resolution from first data, which is a source image, there are two ways to align the second data based on the corners of the first data.

First, the align_corners True method refers to a method of aligning the position of the corner pixel of the first data so that it overlaps the position of the corner pixel of the second data.

Next, the align_corners False method refers to a method in which the position of the corner pixel of the first data is not aligned so as to overlap with the position of the corner pixel of the second data.

Specifically, in the align_corners False method, pixels of the second data may be regularly placed between all pixels of the first data. Therefore, only when the align_corners False method is used, pixel data of the second data may be generated by applying bilinear interpolation to a plurality of pixel data of the first data. However, the align_corners False method is only for easily explaining examples of the present disclosure, and the present disclosure is not limited thereto.

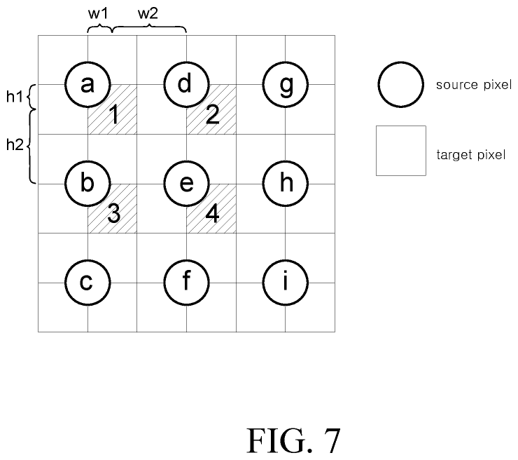

FIGS. 7-10 illustrate methods of the present disclosure in which bilinear interpolation is applied to generate data of a first pixel of second data, data of a second pixel of second data, data of a third pixel of second data, and data of a fourth pixel of second data, respectively.

Based on four pixels of the first data, which are arranged in a 2×2 matrix, bilinear interpolation may be applied to generate four-pixel data of the second data within the four pixels of the first data.

In FIGS. 7 to 10, bilinear interpolation is applied to generate four-pixel data of the second data in a 2×2 shape inside the four pixels of the first data based on four pixels arranged 2×2 in the first data. However, it is not limited thereto and pixel data of a plurality of second data arranged in any N×M shape may be generated within four pixels of the first data. Each of N and M may be a natural number of two or more.

Specifically, in FIG. 7, it is shown that first pixel data of the second data is generated within four pixels of the first data. The first pixel data of the above-described second data refers to pixels 1, 2, 3, and 4 of the second data located in the upper left area within the four pixels of the first data.

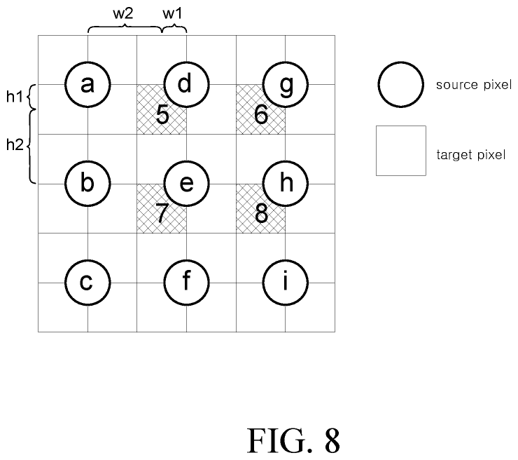

Further, in FIG. 8, it is shown that second pixel data of second data is generated within four pixels of first data. The second pixel data of the above-described second data refers to pixels 5, 6, 7, and 8 of the second data located in the upper right area within the four pixels of the first data.

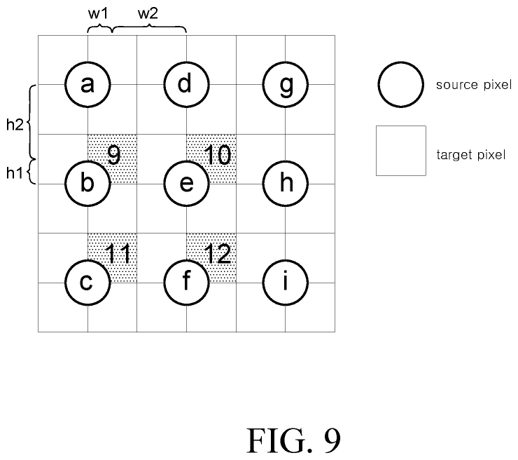

Further, in FIG. 9, it is shown that third pixel data of the second data is generated within four pixels of the first data. The first pixel data of the above-described second data refers to pixels 9, 10, 11, and 12 of the second data located in the lower left area within the four pixels of the first data.

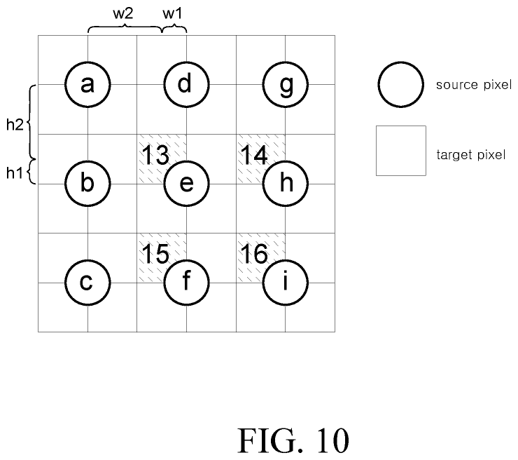

Further, in FIG. 10, it is shown that fourth pixel data of the second data is generated within four pixels of the first data. The second pixel data of the above-described second data refers to pixels 13, 14, 15, and 16 of the second data located in the lower right area within the four pixels of the first data.

First, the first pixel data of the second data shown in FIG. 7 is expressed as follows using the bilinear interpolation method described in FIG. 5.

Based on the a-pixel, d-pixel, b-pixel, and e-pixel of the first data, the first pixel data 1 of the second data may be expressed as W0_1*a+W1_1*b+W2_1*d+W3_1*e, which is a value obtained by convolving the input data

$$( \begin{matrix}a & d \\ b & e\end{matrix} )$$

with the first weight

$$( \begin{matrix}W0\_ 1 & W2\_ 1 \\ W1\_ 1 & W3\_ 1\end{matrix} ) .$$

The convolution operation may be processed in one processing element of the neural processing unit 1000.

Further, based on the d-pixel, g-pixel, e-pixel, and h-pixel of the first data, the first pixel data 2 of the second data may be expressed as W0_1*d+W1_1*e+W2_1*g+W3_1*h, which is a value obtained by convolving the input data

$$( \begin{matrix}d & g \\ e & h\end{matrix} )$$

with the first weight

$$( \begin{matrix}W0\_ 1 & W2\_ 1 \\ W1\_ 1 & W3\_ 1\end{matrix} ) .$$

The convolution operation may be processed in one processing element of the neural processing unit 1000.

Further, based on the b-pixel, e-pixel, c-pixel, and f-pixel of the first data, the first pixel data 3 of the second data may be expressed as W0_1*b+W1_1*c+W2_1*e+W3_1*f, which is a value obtained by convolving the input data

$$( \begin{matrix}b & e \\ c & f\end{matrix} )$$

with the first weight

$$( \begin{matrix}W0\_ 1 & W2\_ 1 \\ W1\_ 1 & W3\_ 1\end{matrix} ) .$$

The convolution operation may be processed in one processing element of the neural processing unit 1000.

Further, based on the e-pixel, h-pixel, f-pixel, and i-pixel of the first data, the first pixel data 4 of the second data may be expressed as W0_1*e+W1_1*f+W2_1*h+W3_1*i, which is a value obtained by convolving the input data

$$( \begin{matrix}e & h \\ f & i\end{matrix} )$$

with the first weight

$$( \begin{matrix}W0\_ 1 & W2\_ 1 \\ W1\_ 1 & W3\_ 1\end{matrix} ) .$$

The convolution operation may be processed in one processing element of the neural processing unit 1000.

Here, W0_1=w2/(w1+w2)*h2/(h1+h2), W1_1=w1/(w1+w2)*h2/(h1+h2), W2_1=w2/(w1+w2)*h1/(h1+h2), and W3_1=w1/(w1+w2)*h1/(h1+h2).

For example, if w1=1, w2=3, h1=1, and h2=3, then W0_1= 9/16, W1_1= 3/16, W2_2= 3/16, and W3_2= 1/16.

As described above, in order to generate the first pixel data of the second data inside the four pixels arranged 2×2 in the first data, only a first weight, which is one kernel, is needed rather than multiple kernels.

Therefore, if only the first weight is known, the first pixel data 1, 2, 3, and 4 of the second data may be calculated by applying bilinear interpolation to four pixels arranged 2×2 in the first data. That is, the first weight may be reused.

As described above, the weight may be a decimal number between zero and one, such as 9/16, 3/16, or 1/16. However, since the first processing element PE1 includes only a multiplier 641, it can only perform integer multiplication operations and cannot perform decimal multiplication operations.

Accordingly, a floating-point multiplier for decimal multiplication operations may be further provided.

Therefore, after performing an integer multiplication operation in the first processing element PE1 and outputting the output feature map data, the final output feature map data may be generated by multiplying the output feature map data by 0.00625, a decimal number corresponding to 1/16, in the floating-point multiplier.

The second pixel data of the second data shown in FIG. 8 may be expressed as follows using the bilinear interpolation method described in FIG. 5.

Based on the a-pixel, d-pixel, b-pixel, and e-pixel of the first data, the second pixel data 5 of the second data may be expressed as W0_2*a+W1_2*b+W2_2*d+W3_2*e, which is a value obtained by convolving the input data

$$( \begin{matrix}a & d \\ b & e\end{matrix} )$$

with the second weight

$$( \begin{matrix}W0\_ 2 & W2\_ 2 \\ W1\_ 2 & W3\_ 2\end{matrix} ) .$$

The convolution operation may be processed in one processing element of the neural processing unit 1000.

Further, based on the d-pixel, g-pixel, e-pixel, and h-pixel of the first data, the second pixel data 6 of the second data may be expressed as W0_2*d+W1_2*e+W2_2*g+W3_2*h, which is a value obtained by convolving the input data

$$( \begin{matrix}d & g \\ e & h\end{matrix} )$$

with the second weight

$$( \begin{matrix}W0\_ 2 & W2\_ 2 \\ W1\_ 2 & W3\_ 2\end{matrix} ) .$$

The convolution operation may be processed in one processing element of the neural processing unit 1000.

Further, based on the b-pixel, e-pixel, c-pixel, and f-pixel of the first data, the second pixel data 7 of the second data may be expressed as W0_2*b+W1_2*c+W2_2*e+W3_2*f, which is a value obtained by convolving the input data

$$( \begin{matrix}b & e \\ c & f\end{matrix} )$$

with the second weight

$$( \begin{matrix}W0\_ 2 & W2\_ 2 \\ W1\_ 2 & W3\_ 2\end{matrix} ) .$$

The convolution operation may be processed in one processing element of the neural processing unit 1000.

Further, based on the e-pixel, h-pixel, f-pixel, and i-pixel of the first data, the second pixel data 8 of the second data may be expressed as W0_2*b+W1_2*c+W2_2*e+W3_2*f, which is a value obtained by convolving the input data

$$( \begin{matrix}e & h \\ f & i\end{matrix} )$$

with the second weight

$$( \begin{matrix}W0\_ 2 & W2\_ 2 \\ W1\_ 2 & W3\_ 2\end{matrix} ) .$$

The convolution operation may be processed in one processing element of the neural processing unit 1000.

Here, W0_2=w1/(w1+w2)*h2/(h1+h2), W1_2=w2/(w1+w2)*h2/(h1+h2), W2_2=w1/(w1+w2)*h1/(h1+h2), and W3_2=w2/(w1+w2)*h1/(h1+h2).

For example, if w1=1, w2=3, h1=1, and h2=3, then W0_2= 3/16, W1_2= 1/16, W2_2= 9/16, and W2_2= 3/16.

As described above, in order to generate second pixel data of the second data inside four pixels arranged 2×2 in the first data, only a second weight, which is one kernel, is needed rather than multiple kernels.

Therefore, if only the second weight is known, the second pixel data 5, 6, 7, and 8 of the second data may be calculated by applying bilinear interpolation to four pixels arranged in 2×2 in the first data. That is, the second weight may be reused.

The third pixel data of the second data shown in FIG. 9 may be expressed as follows using the bilinear interpolation method described in FIG. 5.

Based on the a-pixel, d-pixel, b-pixel, and e-pixel of the first data, the third pixel data 9 of the second data may be expressed as W0_3*a+W1_3*b+W2_3*d+W3_3*e, which is a value obtained by convolving the input data

$$( \begin{matrix}a & d \\ b & e\end{matrix} )$$

with the third weight

$$( \begin{matrix}W0\_ 3 & W2\_ 3 \\ W1\_ 3 & W3\_ 3\end{matrix} ) .$$

The convolution operation may be processed in one processing element of the neural processing unit 1000.

Further, based on the d-pixel, g-pixel, e-pixel, and h-pixel of the first data, the third pixel data 10 of the second data may be expressed as W0_3*d+W1_3*e+W2_3*g+W3_3*h, which is a value obtained by convolving the input data

$$( \begin{matrix}d & g \\ e & h\end{matrix} )$$

with the third weight

$$( \begin{matrix}W0\_ 3 & W2\_ 3 \\ W1\_ 3 & W3\_ 3\end{matrix} ) .$$

The convolution operation may be processed in one processing element of the neural processing unit 1000.

Further, based on the b-pixel, e-pixel, c-pixel, and f-pixel of the first data, the third pixel data 11 of the second data may be expressed as W0_3*b+W1_3*c+W2_3*e+W3_3*f, which is a value obtained by convolving the input data

$$( \begin{matrix}b & e \\ c & f\end{matrix} )$$

with the third weight

$$( \begin{matrix}W0\_ 3 & W2\_ 3 \\ W1\_ 3 & W3\_ 3\end{matrix} ) .$$

The convolution operation may be processed in one processing element of the neural processing unit 1000.

Further, based on the e-pixel, h-pixel, f-pixel, and i-pixel of the first data, the third pixel data 12 of the second data may be expressed as W0_3*e+W1_3*f+W2_3*h+W3_3*i, which is a value obtained by convolving the input data

$$( \begin{matrix}e & h \\ f & i\end{matrix} )$$

with the third weight

$$( \begin{matrix}W0\_ 3 & W2\_ 3 \\ W1\_ 3 & W3\_ 3\end{matrix} ) .$$

The convolution operation may be processed in one processing element of the neural processing unit 1000.

Here, W0_3=w2/(w1+w2)*h1/(h1+h2), W1_3=w1/(w1+w2)*h1/(h1+h2), W2_3=w2/(w1+w2)*h2/(h1+h2), and W3_3=w1/(w1+w2)*h2/(h1+h2).

For example, if w1=1, w2=3, h1=1, and h2=3, then, W0_3= 3/16, W1_3= 1/16, W2_4= 9/16, and W3_4= 3/16.

As described above, in order to generate third pixel data of the second data within four pixels arranged 2×2 in the first data, only a third weight, which is one kernel, is needed rather than multiple kernels.

Therefore, if only the third weight is known, the third pixel data 9, 10, 11, and 12 of the second data may be calculated by applying bilinear interpolation to four pixels arranged 2×2 in the first data. That is, the third weight may be reused.

The fourth pixel data 13, 14, 15, and 16 of the second data shown in FIG. 10 is expressed using the bilinear interpolation method described in FIG. 5 as follows.

Based on the a-pixel, d-pixel, b-pixel, and e-pixel of the first data, the fourth pixel data 13 of the second data may be expressed as W0_4*a+W1_4*b+W2_4*d+W3_4*e, which is a value obtained by convolving the input data

$$( \begin{matrix}a & d \\ b & e\end{matrix} )$$

with the fourth weight

$$( \begin{matrix}W0\_ 4 & W2\_ 4 \\ W1\_ 4 & W3\_ 4\end{matrix} ) .$$

The convolution operation may be processed in one processing element of the neural processing unit 1000.

Further, based on the d-pixel, g-pixel, e-pixel, and h-pixel of the first data, the fourth pixel data 14 of the second data may be expressed as W0_4*d+W1_4*e+W2_4*g+W3_4*h, which is a value obtained by convolving the input data

$$( \begin{matrix}d & g \\ e & h\end{matrix} )$$

with the fourth weight

$$( \begin{matrix}W0\_ 4 & W2\_ 4 \\ W1\_ 4 & W3\_ 4\end{matrix} ) .$$

The convolution operation may be processed in one processing element of the neural processing unit 1000.

Further, based on the b-pixel, e-pixel, c-pixel, and f-pixel of the first data, the fourth pixel data 15 of the second data may be expressed as W0_4*b+W1_4*c+W2_4*e+W3_4*f, which is a value obtained by convolving the input data

$$( \begin{matrix}b & e \\ c & f\end{matrix} )$$

with the fourth weight

$$( \begin{matrix}W0\_ 4 & W2\_ 4 \\ W1\_ 4 & W3\_ 4\end{matrix} ) .$$

The convolution operation may be processed in one processing element of the neural processing unit 1000.

Further, based on the e-pixel, h-pixel, f-pixel, and i-pixel of the first data, the fourth pixel data 16 of the second data may be expressed as W0_4*e+W1_4*f+W2_4*h+W3_4*i, which is a value obtained by convolving the input data

$$( \begin{matrix}e & h \\ f & i\end{matrix} )$$

with the fourth weight

$$( \begin{matrix}W0\_ 4 & W2\_ 4 \\ W1\_ 4 & W3\_ 4\end{matrix} ) .$$

The convolution operation may be processed in one processing element of the neural processing unit 1000.

Here, W0_4=w1/(w1+w2)*h1/(h1+h2), W1_4=w2/(w1+w2)*h1/(h1+h2), W2_4=w1/(w1+w2)*h2/(h1+h2), and W3_4=w2/(w1+w2)*h2/(h1+h2).

For example, if w1=1, w2=3, h1=1, and h2=3, then W0_4= 1/16, W1_4= 3/16, W2_4= 3/16, and W3_4= 9/16.

As described above, in order to generate the fourth pixel data of the second data inside the four pixels arranged 2×2 in the first data, only a fourth weight, which is one kernel, is needed rather than multiple kernels.

Therefore, if only the fourth weight is known, the fourth pixel data 13, 14, 15, and 16 of the second data may be calculated by applying bilinear interpolation to four pixels arranged 2×2 in the first data. That is, the fourth weight may be reused.

As mentioned above, based on pixels arranged 2×2 in the first data, by performing convolution of the first to fourth weights corresponding to bilinear interpolation, four-pixel data of the second data placed inside the four pixels of the first data may be generated.

As an example, the interpolation operations of FIGS. 7 to 10 may be processed sequentially by one processing element.

As another example, the interpolation operations of FIGS. 7 to 10 may be processed in parallel by two processing elements.

As another example, the interpolation operations of FIGS. 7 to 10 may be processed in parallel by three processing elements.

As another example, the interpolation operations of FIGS. 7 to 10 may be processed in parallel by four processing elements.

That is, the controller 300 of the neural processing unit 1000 may determine the positions of rows and columns of specific processing elements and the number of allocated processing elements in order to process bilinear interpolation.

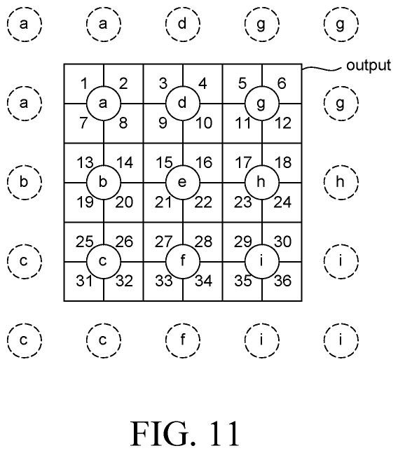

Hereinafter, a method of duplicating first data to generate second data placed outside the first data through bilinear interpolation will be described with reference to FIG. 11. The above-described second data may refer to output.

FIG. 11 illustrates a method of externally replicating first data applicable to the present disclosure.

As described above with reference to FIGS. 7 to 10, a plurality of pixels of the second data generated by performing bilinear interpolation may be arranged between a plurality of pixels of the first data.

That is, as described above with reference to FIGS. 7 to 10, the plurality of pixels 8, 9, 10, 11, 14, 15, 16, 17, 20, 21, 22, 23, 26, 27, 28, and 29 of the second data arranged in the plurality of pixels a, b, c, d, e, f, g, h, and i of the first data as illustrated in circular solid lines may be calculated by performing bilinear interpolation based on the plurality of pixels a, b, c, d, e, f, g, h, and i of the first data indicated by circular solid lines in FIG. 11.

However, in FIG. 11, bilinear interpolation may not be performed to the plurality of pixels 1, 2, 3, 4, 5, 6, 7, 12, 13, 18, 19, 24, 25, 31, 32, 33, 34, 35, and 36 of the second data arranged outside the plurality of pixels a, b, c, d, e, f, g, h, and i of the first data illustrated as a circular solid line with only the plurality of pixels a, b, c, d, e, f, g, h, and i of the first data indicated by a circular solid line.

Accordingly, in order to calculate the plurality of pixels 1, 2, 3, 4, 5, 6, 7, 12, 13, 18, 19, 24, 25, 31, 32, 33, 34, 35, and 36 of the second data disposed outside the first data, the outermost plurality of pixel data a, b, c, d, f, g, h, and i of the first data may be copied to the outside of the second data (i.e., output).

That is, by duplicating pixel a on the upper side of pixel a, pixel a on the left side of pixel a, and pixel a on the upper left side of pixel a, one pixel of the second data may be calculated through bilinear interpolation.

Then, by duplicating pixel a on the upper side of pixel a and by duplicating pixel d on the upper side of pixel d, the pixel 2 and the pixel 3 of the second data may be calculated through bilinear interpolation.

Then, by duplicating pixel d on the upper side of pixel d and by duplicating pixel g on the upper side of pixel g, the pixel 4 and the pixel 5 of the second data may be calculated through bilinear interpolation.

Then, by duplicating pixel g on the upper side of pixel g, pixel g on the right side of pixel g, and pixel g on the upper right side of pixel g, the pixel 6 of the second data may be calculated through bilinear interpolation.

Then, by duplicating pixel a on the left side of pixel a and by duplicating pixel b on the left side of pixel b, the pixel 7 and the pixel 13 of the second data may be calculated through bilinear interpolation.

Then, by duplicating pixel g on the right side of pixel g and by duplicating pixel h on the right side of pixel h, the pixel 12 and the pixel 18 of the second data may be calculated through bilinear interpolation.

Then, by duplicating pixel b on the left side of pixel b and by duplicating pixel c on the left side of pixel c, the pixel 19 and the pixel 25 of the second data may be calculated through bilinear interpolation.

Then, by duplicating pixel h on the right side of pixel h and by duplicating pixel i on the right side of pixel i, the pixel 24 and the pixel 30 of the second data may be calculated through bilinear interpolation.

Then, by duplicating pixel c on the bottom side of pixel c, pixel c on the left side of pixel c, and pixel c on the bottom left side of pixel c, the pixel 31 of the second data may be calculated through bilinear interpolation.

Then, by duplicating pixel c on the bottom side of pixel c and by duplicating pixel f on the bottom side of pixel f, the pixel 32 and the pixel 33 of the second data may be calculated through bilinear interpolation.

Then, by duplicating pixel f on the bottom side of pixel f and by duplicating pixel i on the bottom side of pixel i, the pixel 34 and the pixel 35 of the second data may be calculated through bilinear interpolation.

Then, by duplicating pixel i on the bottom side of pixel i, pixel i on the right side of pixel i, and pixel i on the bottom right side of pixel i, the pixel 36 of the second data may be calculated through bilinear interpolation.

As an example, the interpolation operation of FIG. 11 may be processed sequentially by one processing element.

As another example, the interpolation operation of FIG. 11 may be processed in parallel by two processing elements.

As another example, the interpolation operation of FIG. 11 may be processed in parallel by three processing elements.

As another example, the interpolation operation of FIG. 11 may be processed in parallel by four processing elements.

That is, the controller 300 of the neural processing unit 1000 may determine the positions of rows and columns of specific processing elements and the number of allocated processing elements in order to process bilinear interpolation.

Hereinafter, one processing element that performs convolution of the first data and a kernel corresponding to bilinear interpolation will be described with reference to FIG. 11.

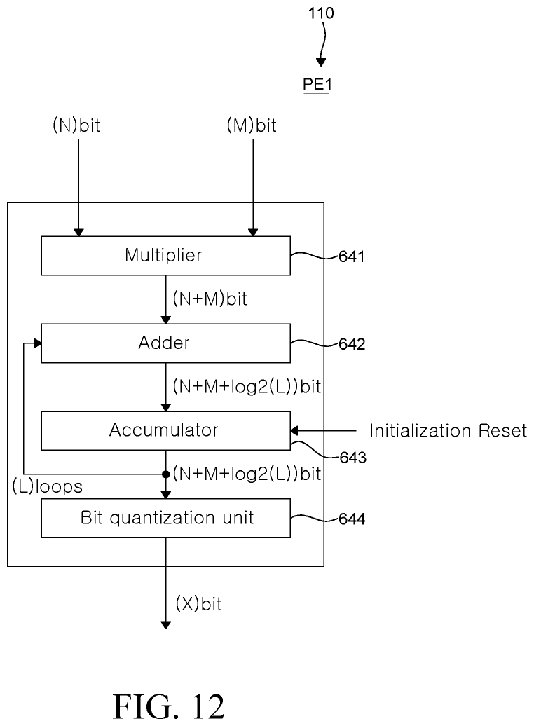

FIG. 12 illustrates one processing element of an array of processing elements related to the present disclosure.

Referring to FIG. 12, the first processing element PE1 may include a multiplier 641, an adder 642, and an accumulator 643.

The first processing element PE1 may optionally include a bit quantization unit 644. However, examples according to the present disclosure are not limited thereto, and the processing element array 100 may be variously modified in consideration of the computational characteristics of the artificial neural network.

The multiplier 641 multiplies the received (N)-bit data and (M)-bit data. The operation value of the multiplier 641 may be output as (N+M) bit data, where N and M are integers greater than zero. The first input unit receiving (N) bit data may be configured to receive a value having a characteristic such as a variable, and the second input unit receiving the (M) bit data may be configured to receive a value having a characteristic such as a constant.

For example, the first input unit may receive feature map data. That is, since the feature map data may be data obtained by extracting features such as an input image and voice, it may be data input from the outside such as a sensor in real time. The feature map data input to the processing element may be referred to as input feature map data. The feature map data output from the processing element after the MAC operation is completed may be referred to as output feature map data. The neural processing unit 1000 may further selectively apply additional operations such as batch normalization, pooling, and activation functions to the output feature map data.

In the present disclosure, input feature map data may be pixel data of first data, and output feature map data may be pixel data of second data.

For example, the second input unit may receive a weight, that is, kernel data. In the present disclosure, the weight may correspond to a bilinear interpolation operation. That is, each element of the plurality of weights may be a coefficient that is input to at least one processing element and multiplied by the plurality of pixel data of the first data to perform bilinear interpolation.

The parameter input to the first input unit of the multiplier 641 may be feature map data of an artificial neural network model or pixel data of the first data. The parameter input to the second input unit may be a weight of an artificial neural network model or a weight corresponding to a bilinear interpolation operation.

In this way, when the controller 300 controls the internal memory 200 by distinguishing the type of input data of the processing element, the controller 300 can increase the data reuse rate.

Based on this, the controller 300 may be configured to control the processing element to reuse the kernel in the processing element, taking into account the characteristics of the kernel for bilinear interpolation.

On the other hand, the neural processing unit 1000 is also capable of performing control of the internal memory 200 optimized for calculation of an artificial neural network model as well as bilinear interpolation.

For example, the controller 300 may confirm that the weight size, input feature map size, and output feature map size of each layer of the artificial neural network model are different from each other.

For example, when the size of the internal memory 200 is determined, and if the size of the input feature map and the size of the output feature map of a specific layer of the artificial neural network model or a tile of a specific layer are smaller than the internal memory 200, then the controller 300 may control the neural processing unit 1000 to reuse feature map data.

For example, when the size of the internal memory 200 is determined, and if the size of the weight of a specific layer or a tile of a specific layer is significantly small, the controller 300 may control the neural processing unit 1000 to reuse feature map data.

Alternatively, when the size of the internal memory 200 is determined, since the size of the weight corresponding to the bilinear interpolation operation is small, the controller 300 may control the neural processing unit 1000 to reuse weights corresponding to the bilinear interpolation operation.

Alternatively, since the capacity of the weights for performing bilinear interpolation is small, they may reside in the internal memory 200 or be stored in a separate non-volatile memory included in the neural processing unit 1000.

That is, the controller 300 may recognize each reusable parameter based on data locality information or structure information including the data reuse information of the artificial neural network model, and may selectively control the internal memory 200 and/or the processing element array 100. For the above operation, the compiler 6000 or the controller 300 may classify parameters below the critical size of the artificial neural network model.

Meanwhile, when zero value is inputted to one of the first input unit and the second input unit of the multiplier 641, the first processing element PE1 may recognize that the operation result is zero even if no operation is performed, and thus, the operation of the multiplier 641 may be limited so that the operation is not performed.

For example, when zero is inputted to one of the first input unit and the second input unit of the multiplier 641, the multiplier 641 may be configured to operate in a zero-skipping manner.

The bit width of data input to the first input unit and the second input unit of the multiplier 641 may be determined according to quantization of each feature map and weight of the artificial neural network model. For example, when the feature map of the first layer is quantized to five bits and the weight of the first layer is quantized to seven bits, the first input unit may be configured to receive five-bit width data, and the second input unit may be configured to receive seven-bit width data.

The neural processing unit 1000 may control the first processing element 110 such that the quantized bit width is converted in real time when the quantized data stored in the internal memory 200 is input to the first processing element 110. That is, the quantized bit width may be different for each layer. Accordingly, the first processing element 110 may receive bit width information from the neural processing unit 1000 whenever the bit width of input data is converted, and converts the bit width based on the provided bit width information to generate input data.

The adder 642 adds the calculated value of the multiplier 641 and the calculated value of the accumulator 643. When L loops is 0, since there is no accumulated data, the operation value of the adder 642 may be the same as the operation value of the multiplier 641. When L loops is 1, a value obtained by adding an operation value of the multiplier 641 and an operation value of the accumulator 643 may be an operation value of the adder.

The accumulator 643 temporarily stores the data output from the output unit of the adder 642 so that the operation value of the adder 642 and the operation value of the multiplier 641 are accumulated by the number of L loops. Specifically, the calculated value of the adder 642 output from the output unit of the adder 642 is input to the input unit of the accumulator 643. The operation value input to the accumulator is temporarily stored in the accumulator 643 and is output from the output unit of the accumulator 643. The output operation value is input to the input unit of the adder 642 by a loop. At this time, the operation value newly output from the output unit of the multiplier 641 is inputted to the input unit 642 of the adder. That is, the operation value of the accumulator 643 and the new operation value of the multiplier 641 are input to the input unit of the adder 642, and these values are added by the adder 642 and outputted through the output unit of the adder 642. The data output from the output unit of the adder 642, that is, a new operation value of the adder 642, is input to the input unit of the accumulator 643, and subsequent operations are performed substantially the same as the above-described operations as many times as the number of loops.

As such, the accumulator 643 temporarily stores the data output from the output unit of the adder 642 in order to accumulate the operation value of the multiplier 641 and the operation value of the adder 642 by the number of loops. Accordingly, data input to the input unit of the accumulator 643 and data output from the output unit may have the same bit width as the data output from the output unit of the adder 642, which is (N+M+log2(L)) bits, where L is an integer greater than zero.

When the accumulation is finished, the accumulator 643 may receive an initialization reset signal to initialize the data stored in the accumulator 643 to zero. However, examples according to the present disclosure are not limited thereto.

The bit quantization unit 644 may reduce the number of bits of data output from the accumulator 643. The bit quantization unit 644 may be controlled by the controller 300. The number of bits of the quantized data may be output as X bits, where X is an integer greater than zero. According to the above configuration, the first processing element 110 may be configured to perform a MAC operation, and the first processing element 110 has an effect of quantizing and outputting the MAC operation result. In particular, such quantization has the effect of further reducing power consumption as the number of L loops increases. In addition, if the power consumption is reduced, there is an effect that the heat generation of the edge device can also be reduced. In particular, reducing heat generation has an effect of reducing the possibility of malfunction due to high temperature of the neural processing unit 1000.

The output data of X bits of the bit quantization unit 644 may be node data of a next layer or input data of convolution. If the artificial neural network model has been quantized, the bit quantization unit may be configured to receive quantized information from the artificial neural network model. However, it is not limited thereto, and the NPU controller 300 may be configured to extract quantized information by analyzing the artificial neural network model. Therefore, the output data X bits may be converted into the quantized number of bits to correspond to the quantized data size and output. The output data X bit of the bit quantization unit 644 may be stored in the internal memory 200 as the number of quantized bits.

The first processing element 110 of the neural processing unit 1000 according to an example of the present disclosure may reduce the number of bits of (N+M+log2(L)) bit data output from the accumulator 643 by the bit quantization unit 644 to the number of bits of X bit. The NPU controller 300 may control the bit quantization unit 644 to reduce the number of bits of the output data by a predetermined bit from a least significant bit (LSB) to a most significant bit (MSB).

When the number of bits of output data is reduced, power consumption, calculation amount, and memory usage of the neural processing unit 1000 may be reduced. However, when the number of bits is reduced below a specific bit width, there may be a problem in that the inference accuracy of the artificial neural network model may be rapidly reduced. Accordingly, the reduction in the number of bits of the output data, that is, the quantization degree, may be determined by comparing the reduction in power consumption, the amount of computation, and the amount of memory usage compared to the reduction in inference accuracy of the artificial neural network model. It is also possible to determine the quantization degree by determining the target inference accuracy of the artificial neural network model and testing it while gradually reducing the number of bits. The quantization degree may be determined for each operation value of each layer.

According to the above-described the first processing element 110, by adjusting the number of bits of N-bit data and M-bit data of the multiplier 641 and reducing the number of bits of the operation value X bit by the bit quantization unit 644, the processing element array may have the effect of reducing power consumption while improving the MAC operation speed, and may have the effect of more efficiently performing the convolution operation of the artificial neural network.

Based on this, the internal memory 200 of the neural processing unit 1000 may be a memory system configured in consideration of the MAC operation characteristics and power consumption characteristics of the processing element array 100.

For example, the neural processing unit 1000 may be configured to reduce the bit width of the operation value of the processing element array 100 in consideration of the MAC operation characteristics and power consumption characteristics of the processing element array 100.

For example, the neural processing unit 1000 may be configured to reduce the bit width of an operation value of the processing element array 100 for reuse of a feature map or a weight of the internal memory 200.

The internal memory 200 of the neural processing unit 1000 may be configured to minimize the power consumption of the neural processing unit 1000.

The internal memory 200 of the neural processing unit 1000 may be a memory system configured to control the memory with low-power in consideration of the parameter size and operation sequences of the artificial neural network model to be operated.

The internal memory 200 of the neural processing unit 1000 may be a low-power memory system configured to reuse a specific memory address in which weight data is stored in consideration of the data size and operation sequences of the artificial neural network model.

Referring again to FIG. 4, the neural processing unit 1000 may be configured to include a special function unit (SFU) 400 configured to process various activation functions for imparting non-linearity. The special function unit 400 may be composed of a plurality of logic gate circuits. Accordingly, the special function unit 400 may be difficult to identify and distinguish with the naked eye, and may be identified through operation thereof.

For example, the activation function may include a sigmoid function, a hyperbolic tangent (tanh) function, a ReLU function, a Leaky-ReLU function, a Maxout function, or an ELU function that derives a non-linear output value with respect to an input value, however, it is not limited thereto. Supporting all activation functions in the neural processing unit 1000 may be technically difficult. Therefore, the neural processing unit 1000 is also capable of approximating various activation functions through a piece-wise linear function approximation algorithm and a piecewise linear function processing circuit. Such activation function may be selectively applied after MAC operation. The operation value to which the activation function is applied to the feature map may be referred to as an activation map.

Meanwhile, the special function unit (SFU) 400 may be configured to include a floating-point multiplier circuit that performs decimal operations.

As described above, the first to fourth weights may be decimal numbers between 0 and 1, such as 9/16, 3/16, and 1/16. However, since the first processing element PE1 includes only a multiplier 641, it can only perform integer multiplication operations and cannot perform decimal multiplication operations.

Accordingly, the first processing element PE1 performs an integer multiplication operation to output the output feature map data, and then the output feature map data is multiplied by 0.00625, a decimal equivalent to 1/16, in a floating-point multiplier. Through calculation, final output feature map data may be generated.

To elaborate, from a design perspective of the neural processing unit 1000, the decimal multiplier circuit may have a relatively smaller number of logic gates than the division circuit. Therefore, if the decimal point multiplier is provided separately from the processing element, the total number of logic gates of the neural processing unit 1000 may be significantly reduced. Additionally, the processing element efficiently handles only the integer arithmetic portion of bilinear interpolation, and a separate decimal multiplier can handle decimal multiplication of bilinear interpolation.

Therefore, as the number of processing elements of the neural processing unit 1000 increases, it may be more effective to separately provide a decimal multiplier for bilinear interpolation. According to the above-described configuration, the size of the neural processing unit 1000 may be reduced and power consumption can also be reduced.

Referring back to FIG. 4, the internal memory 200 may be configured as a volatile memory. Volatile memory stores data only when power is supplied, and the stored data is destroyed when power supply is cut off. The volatile memory may include a static random access memory (SRAM), a dynamic random access memory (DRAM), and the like. The internal memory 200 may preferably be an SRAM, but is not limited thereto.

At least a portion of the internal memory 200 may be configured as a non-volatile memory. Non-volatile memory is memory that stores data even when power is not supplied. The non-volatile memory may include a read only memory (ROM) or the like. It is also possible to store the trained weights in the non-volatile memory. That is, the weight storage unit 210 may include a volatile memory or a non-volatile memory.

The internal memory 200 may include a weight storage unit 210 and a feature map storage unit 220. The weight storage unit 210 may store at least part of the weights of the artificial neural network model or weights corresponding to a bilinear interpolation operation and the feature map storage unit 220 may store at least a portion of the node data or feature map of the artificial neural network model.

The internal memory 200 may be composed of a plurality of logic gate circuits. Accordingly, the internal memory 200 may be difficult to identify and distinguish with the naked eye, and may be identified through operation thereof. The weight storage unit 210 may be composed of a plurality of logic gate circuits. Therefore, the weight storage unit 210 may be difficult to identify and distinguish with the naked eye, and may be identified through operation thereof. The feature map storage unit 220 may be composed of a plurality of logic gate circuits. Therefore, the feature map storage unit 220 may be difficult to identify and distinguish with the naked eye, and may be identified through operation thereof.

The artificial neural network data that may be included in the artificial neural network model may include node data or feature maps of each layer, and weight data of each connection network connecting nodes of each layer. At least some of the data or parameters of the artificial neural network may be stored in a memory provided inside the controller 300 or the internal memory 200.

Among the parameters of the artificial neural network, the feature map may be configured as a batch-channel. Here, the plurality of batch-channels may be, for example, the first data captured by a plurality of image sensors or cameras in a substantially the same period (e.g., within 10 ms or 100 ms).

Meanwhile, the controller 300 may be configured to control the processing element array 100 and the internal memory 200 in consideration of the size of the weight values of the artificial neural network model, the size of the feature map, and the calculation sequence of the weight values and the feature map.

The controller 300 may control the processing element array 100 and the internal memory 200.

For example, the controller 300 may load the weight of the artificial neural network model corresponding to the first input data or the weight corresponding to the bilinear interpolation operation into the weight storage unit 210 of the internal memory 200 and may load feature map data of the artificial neural network model corresponding to the second input data or pixel data of the first data into the feature map storage unit 220 of the internal memory 200. The controller 300 may control the processing element array 100 to calculate weights and feature map data through a first convolution operation in each of the plurality of processing elements constituting the processing element array 100.

Although the internal memory 200 is shown as separately including a weight storage unit 210 and a feature map storage unit 220, this is only an example, however, the internal memory may be logically divided, variably divided, or not divided through memory addresses and the like.

To elaborate, the size of the weight storage unit 210 and the size of the feature map storage unit 220 may be different for each layer and each tile.

In the example described above, the parameters of the artificial neural network are described as being stored in the internal memory 200 of the neural processing unit 1000, but are not limited thereto and may be stored in the on-chip memory 3000 or the main memory 4000.

Below, the processing element array in which the neural processing unit 1000 calculates bilinear interpolation through depth-wise convolution will be described in detail.

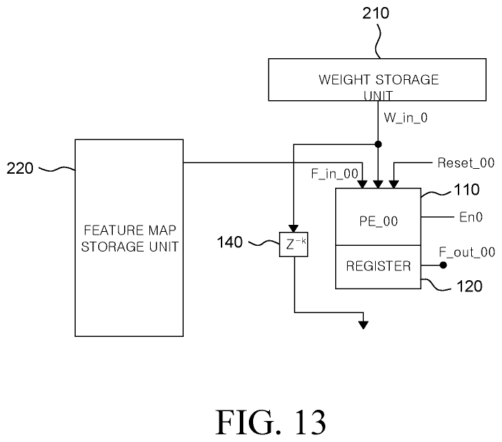

FIG. 13 illustrates one processing element among the processing element array according to an example of the present disclosure.

In order to explain the operation of the processing element in detail in the presented example, the components described with reference to FIG. 4 (i.e., the weight storage unit 210 and the feature map storage unit 220) will be used.

Referring to FIG. 13, a first processing element PE_00, one of a plurality of processing elements, is provided with a register 120 corresponding to the first processing element PE_00. Register 120 may be referred to as a register file. The register 120 may correspond to a temporary memory that stores the accumulated value of the accumulator 643 shown in FIG. 12. The register 120 may be composed of a plurality of logic gate circuits. Accordingly, the register 120 may be difficult to identify with the naked eye, and may be identified through operation thereof.

The first processing element PE_00 may be connected to the weight storage unit 210 and connected to the signal line W_in_0 through which the weight is transmitted and the first processing element PE_00 may be connected to the feature map storage unit 220 and connected to a signal line F_in_0 through which feature map data is transmitted.

The above-mentioned weights may be weights of an artificial neural network model or weights corresponding to a bilinear interpolation operation. Further, the above-described feature map data may be feature map data of an artificial neural network model or pixel data of first data.

The first processing element PE_00 may perform an operation (e.g., MAC operation) on the weight delivered from the weight storage unit 210 and the feature map data delivered from the feature map storage unit 220, and stores the operation value in a register 120. Here, the operation value may be a feature map data representing the result of MAC calculation of weights on feature map data. For example, it may take four clock cycles for the first processing element PE_00 to perform a convolution operation with a weight kernel of a 2×2 matrix. The value accumulated over four clock cycles may be stored in the register 120. When the operation is completed in the first processing element PE_00, a reset signal Reset_00 that initializes the operation value is received, which may initialize the operation value of the first processing element PE_00.

The first processing element PE_00 may be configured to reduce power consumption of the neural processing unit 1000 by applying an enable signal En0 depending on whether the first processing element PE_00 is operating. Additionally, the utilization rate of the processing element array 100 of the neural processing unit 1000 may be determined depending on whether each processing element is operating.

The operation of each processing element may be controlled by the controller 300. The controller 300 may be configured to generate an enable signal corresponding to each processing element.

Register 120 may refer to the register file 120 described above with reference to FIG. 4. When an output command signal for outputting a calculation value to the feature map storage unit 220 is received, the register 120 may output the calculation value through an output signal line F_out_00 connected to the feature map storage unit 220 and the output calculated value may be stored in the feature map storage unit 220. This register 120 may be optionally provided.

When the register 120 is not provided, the operation value of the first processing element PE_00 may be configured to be directly transmitted to and stored in the feature map storage unit 220.

The first processing element PE_00 may be connected to a signal line F_out_00 through which output data is transmitted when the MAC operation is completed. The signal line F_out_00 may be connected to the internal memory 200 or to a decimal multiplier (not shown), a separate vector processing unit (not shown), or an activation function operation unit (not shown).

To elaborate, a processing element according to examples of the present disclosure may be configured to transmit the input weight to another processing element. Accordingly, since the transmitted weights may be reused within the processing element array, the number of times the weights are reloaded from the internal memory 200, on-chip memory 3000, and/or main memory 4000 may be reduced.

In addition to the register 120, the first processing element PE_00 may further include a delay buffer 140 corresponding to the first processing element PE_00.

The delay buffer 140 may be composed of a plurality of logic gate circuits. Accordingly, the delay buffer 140 may be difficult to identify with the naked eye, and may be identified through operation thereof.

The delay buffer 140 can delay the input signal for a specific clock period. For example, if the delay buffer 140 is delayed by one clock cycle, it may be indicated as Z⁻¹. For example, if the delay buffer 140 is delayed by two clock cycles, it may be indicated as Z⁻². For example, if the delay buffer 140 is delayed by four clock cycles, it may be indicated as Z⁻⁴. For example, if the delay buffer 140 is delayed by six clock cycles, it may be indicated as Z⁻⁶.

However, in FIG. 13, it is illustrated as Z₋ₖ to represent the delay buffer 140 that delays the input signal for a specific clock period or by a specific number of clock cycles.

The delay buffer 140 temporarily stores the weight W_in_0 transmitted from the weight storage unit 210 for a preset clock amount and then outputs it. The weight W_in_0 output from the delay buffer 140 is input to the processing element in the next row. The weight W_in_0 output from the delay buffer 140 may be a weight delayed by a preset clock.

In FIG. 13, the delay buffer 140 is shown as consisting of one delay buffer, but the delay buffer 140 is not limited thereto and may be comprised of a plurality of delay buffers connected in series. For example, two delay buffers connected in series can delay by two clock cycles. For example, three delay buffers connected in series can delay by three clock cycles.

For example, when the delay buffer 140 consists of a first delay buffer and a second delay buffer connected in series, the delay buffer 140 may delay data by the number of clock cycles that is the sum of the number of clock cycles delayed by the first delay buffer and the number of clock cycles delayed by the second delay buffer.

According to the delay buffer of the processing element array according to examples of the present disclosure, processing elements corresponding to at least some columns of the processing element array may be configured to perform a depth-wise convolution operation using the delay buffer 140.

That is, when the weights in the form of a matrix are convolved in a specific processing element by the delay buffer 140 by sliding the feature map data in the form of a matrix by a preset interval, some of the weights may be reused for convolution operations in other adjacent processing elements.

By reusing some of the reused weights in this way using the delay buffer 140 rather than repeatedly loading them from the weight storage unit 210 to the processing element array 100, depth-wise convolution calculation performance may be improved.

On the other hand, the processing elements operated in the processing element array 100 are activated by the enable signal EnO, and the remaining processing elements that are not operated are deactivated, thereby reducing power consumption of the neural processing unit 1000.

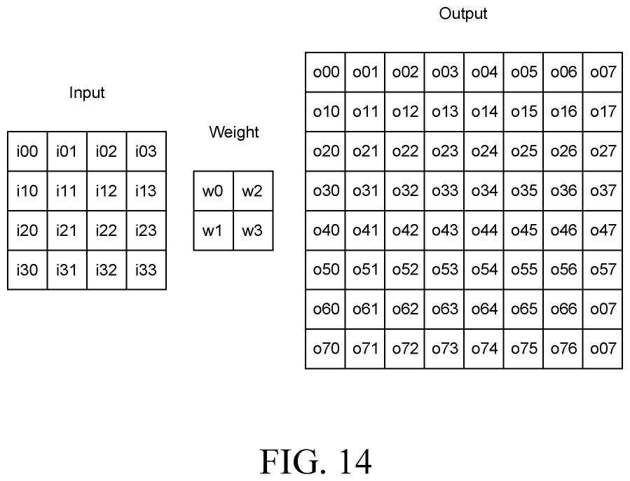

Hereinafter, the processing element array in which these processing elements are configured in a matrix form and its operation method will be described with reference to FIGS. 14 to 27.

FIG. 14 illustrates input data and output data input to a processing element array according to an example of the present disclosure.

Referring to FIG. 14, the weight used in the bilinear interpolation operation, which is the first input data, may have a size of 2×2. In other words, since the bilinear interpolation operation is an operation in which linear interpolation is performed twice on a two-dimensional plane, the weight used in the bilinear interpolation operation may be fixed to a size of 2×2. For example, weight values used in a bilinear interpolation operation may be expressed as w0, w1, w2, and w3.

Pixel data of the first data, which is the second input data, may have a size of 4×4. For example, the pixel data of the first data may be expressed as i00, i01, i02, i03, i10, i11, i12, i13, i20, i21, i22, i23, i30, i32, and i33. However, the size of the pixel data of the first data, which is the second input data, is not limited thereto and may be changed to various sizes.

Pixel data of the second data with expanded resolution, which is the output data, may have a size of 8×8. For example, the pixel data of the second data is o00, o01, o02, o03, o04, o05, o06, o07, . . . , o70, o71, o72, o73, o74, o75, o76, and o77. However, the pixel data of the second data with expanded resolution, which is output data, is not limited thereto and may be changed to various sizes.

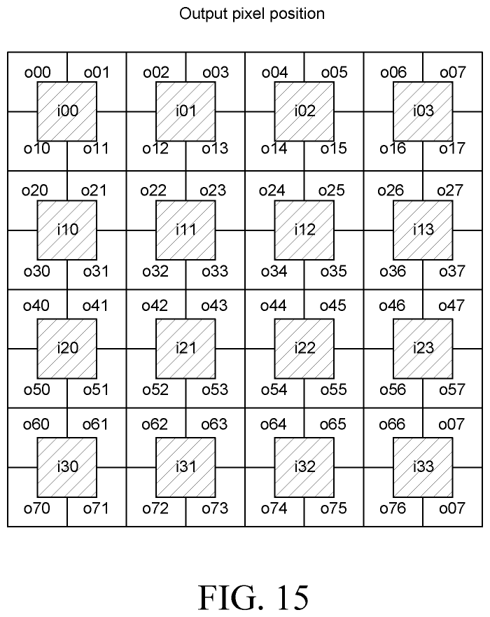

FIG. 15 shows the arrangement relationship between input data and output data input to a processing element array according to an example.

Referring to FIG. 15, pixel data of four pixels of second data arranged in a 2×2 shape may be placed between pixel data of four pixels of first data arranged in a 2×2 shape.

For example, o11, o12, o21, and o22 may be placed between i00, i01, i10, and i11. Further, o13, o14, o23, and o24 may be placed between i01, i02, i11, and i12. Further, o15, o16, o25, and o26 may be placed between i02, i03, i13, and i13.

In addition, o31, o32, o41, and o42 may be placed between i10, i11, i20, and i21. Further, o33, o34, o43, and o44 may be placed between i11, i12, i21, and i22. Further, o35, o36, o45, and o46 may be placed between i12, i13, i23, and i23.

In addition, o51, o52, o61, and o62 may be placed between i20, i21, i30, and i31. Further, o53, o54, o63, and o64 may be placed between i21, i22, i31, and i32. Further, o55, o56, o65, and o66 may be placed between i22, i23, i33, and i33.

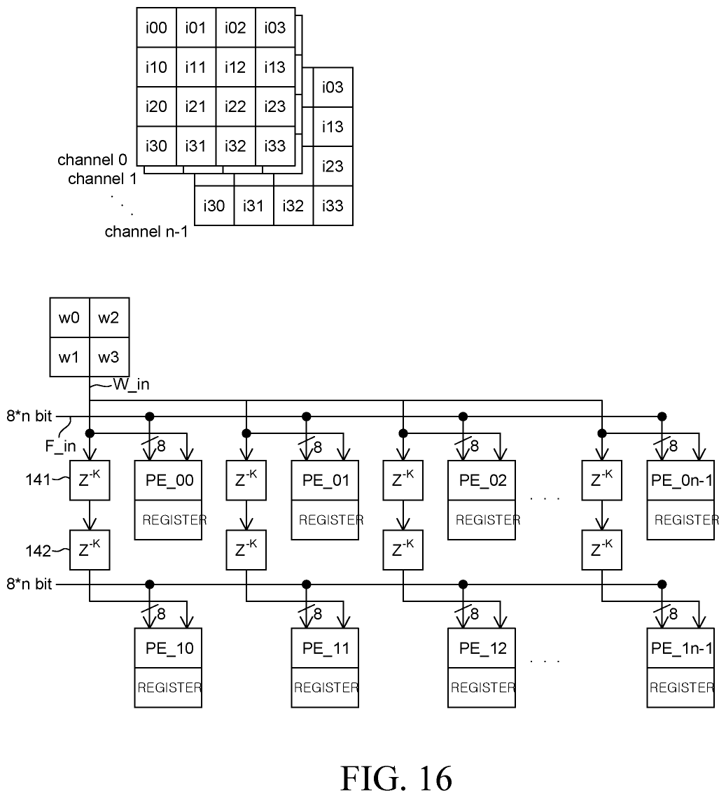

FIG. 16 illustrates the structure of a processing element array according to an example of the present disclosure.

Referring to FIG. 16, the processing element array 100 may include a plurality of processing elements including a plurality of PE rows and a plurality of PE columns.

Multiple processing elements can process bilinear interpolation operations faster than a single processing element. Therefore, the neural processing unit 1000 configured to utilize a plurality of processing elements for bilinear interpolation calculation can quickly process bilinear interpolation operation.

To elaborate, the first PE row may refer to a plurality of processing elements PE_00 through PE_0n−1 arranged in the first row. The second PE row may refer to a plurality of processing elements PE_10 through PE_1n−1 arranged in the second row.

To elaborate, the first PE column may refer to a plurality of processing elements PE_00 through PE_0n−1 arranged in the first column. The second PE column may refer to the second plurality of processing elements (PE_01, PE_11, . . . ) arranged in the second column. The third PE column may refer to a plurality of processing elements (PE_02, PE_12, . . . ) arranged in the third column. The n−1th PE column may refer to the nth plurality of processing elements (PE_0n−1, PE_1n−1, . . . ) arranged in the n−1th column.

Referring to FIGS. 13 and 16, the first PE column PE_00, PE_01, PE_02, . . . , and PE_0n−1 may be connected to the weight storage unit 210 through a signal line W_in through which the weight is transmitted. The weight output from the weight storage unit 210 is input to the first PE column PE_00 to PE_0n−1 through the branch of the signal line W_in through which each weight is transmitted. More specifically, the weights used in the bilinear interpolation operation for each of the first PE column PE_00 to PE_0n−1 may be broadcasted. That is, the same weight may be input to each of the first PE column PE_00 to PE_0n−1 at the same timing.

Meanwhile, a plurality of delay buffers 141 and 142 may also be connected to the weight storage unit 210 through a signal line W_in through which the weight is transmitted. The weights output from the weight storage unit 210 are input to the plurality of delay buffers 141 and 142 through the branches of the signal line W_in through which each weight is transmitted. That is, the weights used in the bilinear interpolation operation may be broadcast to the plurality of delay buffers 141 and 142.

More specifically, a plurality of delay buffers 141 and 142 may be composed of a first delay buffer 141 and a second delay buffer 142 connected in series. The first delay buffer 141 may have a delay characteristic (Z⁻¹) of one clock cycle. That is, the k value of the first delay buffer 141, which delays one clock cycle, may be −1. The second delay buffer 142 may have a delay characteristic (Z⁻¹) of one clock cycle. That is, the k value of the second delay buffer 141, which delays by one clock cycle, may be −1.

In this case, the first delay buffer 141 may be connected to the weight storage unit 210 through a signal line W_in_0 through which the weight is transmitted. Further, the second delay buffer 142 may be connected to the second PE column.

Accordingly, the weight used in the bilinear interpolation operation is input to the first delay buffer 141. In addition, the first delay buffer 141 may delay the weight used in the input bilinear interpolation operation by one clock cycle and output the delay to the second delay buffer 142. Additionally, the second delay buffer 142 may additionally delay the weight used in the input bilinear interpolation operation by one clock cycle and output the weight to the second PE column. As a result, a weight delayed by two clock cycles by the first delay buffer 141 and the second delay buffer 142 may be input to the second PE column. As another example, the plurality of delay buffers 141 and 142 may be one delay buffer that delays by two clock cycles. In this case, the k value of the delay buffer may be −2.

That is, the weight that is delayed and transmitted through the delay buffer Z^{-k} may be delayed broadcasting in each PE column direction. Accordingly, the weight transmitted from the weight storage unit 210 may be reused in each PE for which the delayed weight is provided by delayed broadcasting. Through this, the weights may be reused within the processing element array 100 to minimize resource consumption and memory usage used for calculations. Here, the weight may be a weight for the inference operation of an artificial neural network model or a weight for bilinear interpolation.

Meanwhile, each of the plurality of PE rows may be connected to the feature map storage unit 220 through a F_in signal line through which feature map data is transmitted. The feature map data output from the feature map storage unit 220 is input to each of the plurality of PE rows through each F_in signal line. For example, n-channel feature map data may be unicasted or broadcasted to the first PE row and the second PE row, respectively.

The F_in signal line may be a bus consisting of n channels. The F_in signal line may be a bus line including individual signal lines corresponding to one PE row. For example, if the first PE row (PE_00, PE_01, . . . ) is configured to have 64 processing elements, the F_in signal line may be a bus line composed of 64 lines. Further, the F_in signal line may be configured to unicast individual feature map data or broadcast the same feature map data to each processing element in the PE row.

In this way, when feature map data and weights are input to each processing element, MAC operation on the feature map data and weights input from each processing element is performed every clock. Operation result data (i.e., feature map data) calculated through the MAC operation may be output from each processing element and stored in the feature map storage unit 220.

To elaborate, although omitted in FIG. 16, referring again to FIG. 13, each processing element may be configured to include a signal line F_out that outputs the MAC operation value from a register where the MAC operation value is stored. However, the present disclosure is not limited thereto, and the signal line F_out may be configured to be connected to a decimal multiplier circuit, the internal memory 200, or another additional arithmetic circuit.

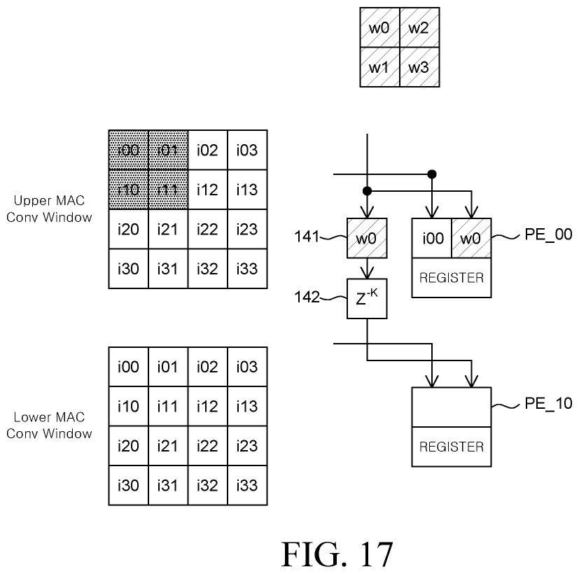

Hereinafter, a method in which a processing element array performs a depth convolution operation will be described with reference to FIGS. 17 to 27.

FIGS. 17 to 27 are diagrams for explaining how a processing element array according to an example of the present disclosure operates during a plurality of clock cycles.

FIGS. 17 to 27 illustrate a process in which the first PE column performs convolution on input data of one channel among input data of n channels during a plurality of clock cycles.

Referring to FIG. 17, during a first clock period, the first processing element PE_00 receives the weight w0 and the pixel data i00 of the first data. Then, the first processing element PE_00 performs a multiplication operation between the weight w0 and the pixel data i00 of the first data and stores the operation value in a register. That is, the value w0*i00 is stored in the register connected to the first processing element PE_00.

Meanwhile, referring to FIG. 17, the weight w0 is also input to the first delay buffer 141 during the first clock period. Further, the first delay buffer 141 stores the weight w0 during the first clock period and delays it by one clock cycle.

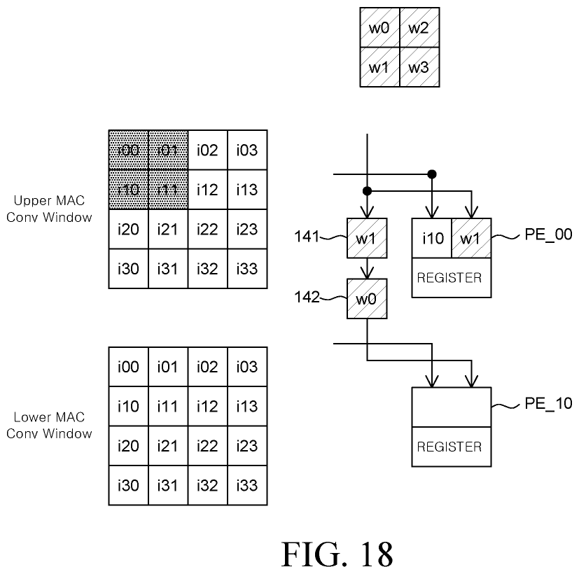

Referring to FIG. 18, during a second clock period, the first processing element PE_00 receives the weight w1 and the pixel data i10 of the first data. Then, the first processing element PE_00 performs a multiplication operation between the weight w1 and the pixel data i10 of the first data and stores the operation value in a register. That is, the value w0*i00+w1*i10 is stored in the register connected to the first processing element PE_00. In other words, the value of w1*i10 is accumulated to the value of w0*i00.

Meanwhile, referring to FIG. 18, the weight w1 is also input to the first delay buffer 141 during the second clock period and the first delay buffer 141 stores the weight w1 during the second clock period and delays it by one clock cycle. Here, the k value of the first delay buffer 141 is −1.

Then, the weight w0 delayed by one clock cycle from the first delay buffer 141 is input to the second delay buffer 142 and the second delay buffer 142 delays the weight w0 by one additional clock cycle during the second clock period. That is, the weight w0 may be delayed by two clock cycles through the first delay buffer 141 and the second delay buffer 142. Here, the k value of the second delay buffer 142 is −1.

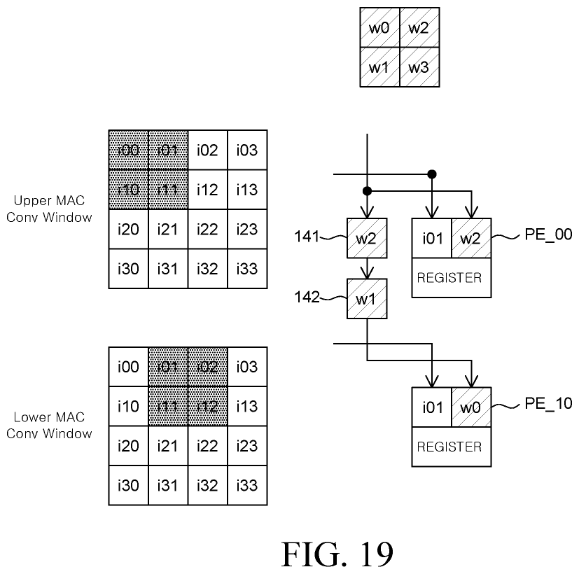

Referring to FIG. 19, during a third clock period, the first processing element PE_00 receives the weight w2 and the pixel data i01 of the first data. Then, the first processing element PE_00 performs a multiplication operation between the weight w2 and the pixel data i01 of the first data and stores the operation value in a register. That is, the value of w0*i00+w1*i10+w2*i01 is stored in the register connected to the first processing element PE_00. That is, operation values may be accumulated in a processing element.

Meanwhile, referring to FIG. 19, the weight w2 is also input to the first delay buffer 141 during the third clock period and the first delay buffer 141 stores the weight w2 during the third clock period and delays it by one clock cycle.

Then, the weight w1 delayed by one clock cycle from the first delay buffer 141 is input to the second delay buffer 142 and the second delay buffer 142 delays the weight w1 by one additional clock cycle during the third clock period. That is, the weight w1 may be delayed by two clock cycles through the first delay buffer 141 and the second delay buffer 142.

Meanwhile, referring to FIG. 19, during the third clock period, the second processing element PE_10 receives the weight w0 from the second delay buffer 142 and the pixel data i01 of the first data. Then, the second processing element PE_10 performs a multiplication operation between the weight w0 and the pixel data i01 of the first data and stores the operation value in a register. That is, the value w0*i01 is stored in the register connected to the second processing element PE_10.

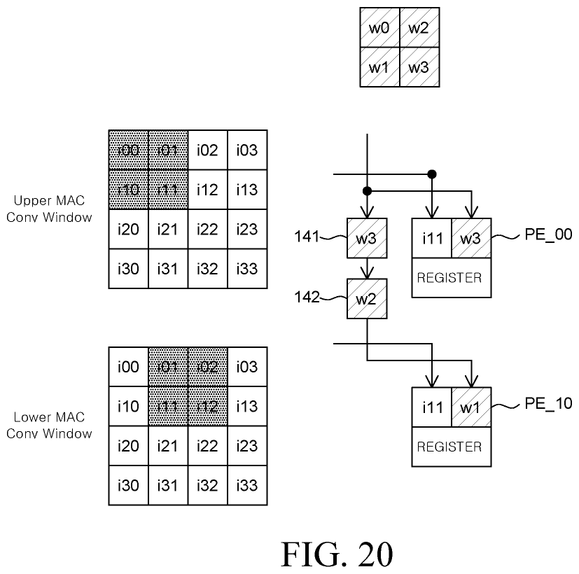

Referring to FIG. 20, during a fourth clock period, the first processing element PE_00 receives the weight w3 and the pixel data i11 of the first data. Then, the first processing element PE_00 performs a multiplication operation between the weight w3 and the pixel data i11 of the first data and stores the operation value in a register. That is, the value of w0*i00+w1*i10+w2*i01+w3*i11 is stored in the register connected to the first processing element PE_00. That is, operation values may be accumulated in a processing element.

Meanwhile, referring to FIG. 20, the weight w3 is also input to the first delay buffer 141 during the fourth clock period and the first delay buffer 141 stores the weight w3 during the fourth clock period and delays it by one clock cycle.

Then, the weight w2 delayed by one clock cycle from the first delay buffer 141 is input to the second delay buffer 142 and the second delay buffer 142 delays the weight w2 by one additional clock cycle during the fourth clock period. That is, the weight w2 may be delayed by two clock cycles through the first delay buffer 141 and the second delay buffer 142.

Meanwhile, referring to FIG. 20, during the fourth clock period, the second processing element PE_10 receives the weight w1 from the second delay buffer 142 and the pixel data i11 of the first data. Then, the second processing element PE_10 performs a multiplication operation between the weight w1 and the pixel data i11 of the first data and stores the operation value in a register. That is, the value w0*i01+w1*i11 is stored in the register connected to the second processing element PE_10. That is, operation values may be accumulated in a processing element.

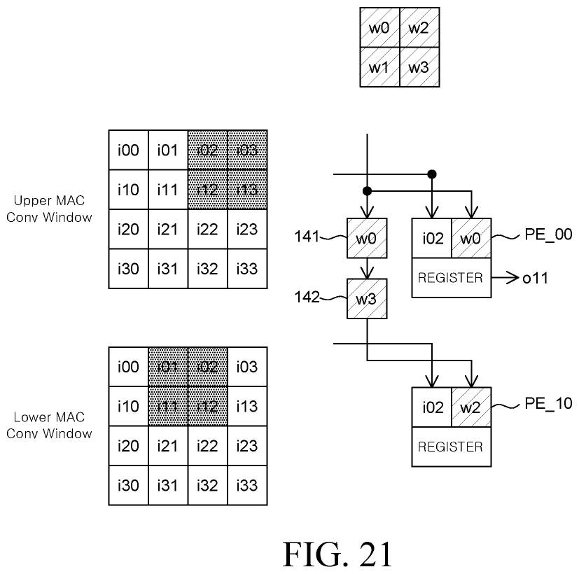

Referring to FIG. 21, the value w0*i00+w1*i10+w2*i01+w3*i11 stored in the register connected to the first processing element PE_00 during a fifth clock period is output as pixel data o11 of the second data.

During the fifth clock period, the first processing element PE_00 receives the weight w0 and the pixel data i02 of the first data. Then, the first processing element PE_00 performs a multiplication operation between the weight w0 and the pixel data i02 of the first data and stores the operation value in a register. That is, the value w0*i02 is stored in the register connected to the first processing element PE_00.

Meanwhile, referring to FIG. 21, during the fifth clock period, the weight w0 is also input to the first delay buffer 141 and the first delay buffer 141 stores the weight w0 for the fifth clock period and delays it by one clock cycle.

Then, the weight w3 delayed by one clock cycle from the first delay buffer 141 is input to the second delay buffer 142 and the second delay buffer 142 delays the weight w3 by one additional clock cycle during the fifth clock period. That is, the weight w3 may be delayed by two clock cycles through the first delay buffer 141 and the second delay buffer 142.

Meanwhile, referring to FIG. 21, during the fifth clock period, the second processing element PE_10 receives the weight w2 from the second delay buffer 142 and the pixel data i02 of the first data. Then, the second processing element PE_10 performs a multiplication operation between the weight w2 and the pixel data i02 of the first data and stores the operation value in a register. That is, the value of w0*i01+w1*i11+w2*i02 is stored in the register connected to the second processing element PE_10. That is, operation values may be accumulated in a processing element.

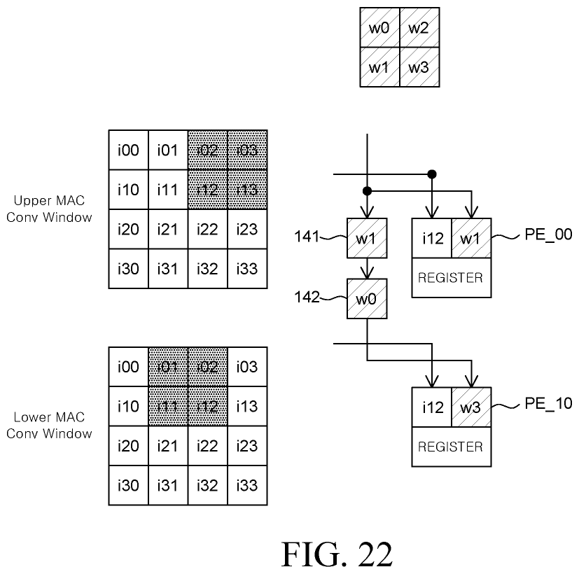

Referring to FIG. 22, during a sixth clock period, the first processing element PE_00 receives the weight w1 and the pixel data i12 of the first data. Then, the first processing element PE_00 performs a multiplication operation between the weight w1 and the pixel data i12 of the first data and stores the operation value in a register. That is, the value w0*i02+w1*i12 is stored in the register connected to the first processing element PE_00. That is, operation values may be accumulated in a processing element.

Meanwhile, referring to FIG. 22, during the sixth clock period, the weight w1 is also input to the first delay buffer 141 and the first delay buffer 141 stores the weight w1 for the sixth clock period and delays it by one clock cycle.

Then, the weight w0 delayed by one clock cycle from the first delay buffer 141 is input to the second delay buffer 142. Additionally, the second delay buffer 142 delays the weight w0 by one additional clock cycle during the sixth clock period. That is, the weight w0 may be delayed by two clock cycles through the first delay buffer 141 and the second delay buffer 142.

Meanwhile, referring to FIG. 22, during the sixth clock period, the second processing element PE_10 receives the weight w3 from the second delay buffer 142 and the pixel data i12 of the first data. Then, the second processing element PE_10 performs a multiplication operation between the weight w3 and the pixel data i12 of the first data and stores the operation value in a register. That is, the value of w0*i01+w1*i11+w2*i02+w3*i12 is stored in the register connected to the second processing element PE_10. That is, operation values may be accumulated in a processing element.

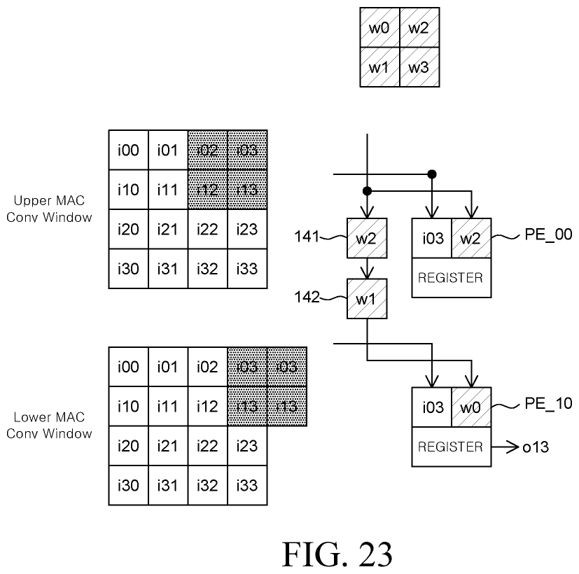

Referring to FIG. 23, during a seventh clock period, the first processing element PE_00 receives the weight w2 and the pixel data i03 of the first data. Then, the first processing element PE_00 performs a multiplication operation between the weight w2 and the pixel data i03 of the first data and stores the operation value in a register. That is, the value of w0*i02+w1*i12+w2*i03 is stored in the register connected to the first processing element PE_00. That is, operation values may be accumulated in a processing element.

Meanwhile, referring to FIG. 23, during the seventh clock period, the weight w2 is also input to the first delay buffer 141 and the first delay buffer 141 stores the weight w2 for the seventh clock period and delays it by one clock cycle.

Then, the weight w1 delayed by one clock cycle from the first delay buffer 141 is input to the second delay buffer 142 and the second delay buffer 142 delays the weight w1 by one additional clock cycle during the seventh clock period. That is, the weight w1 may be delayed by two clock cycles through the first delay buffer 141 and the second delay buffer 142.

Meanwhile, referring to FIG. 23, during the seventh clock period, the value of w0*i01+w1*i11+w2*i02+w3*i12 stored in the register connected to the second processing element PE_10 is output as pixel data o13 of the second data.

During the seventh clock period, the second processing element PE_10 receives the weight w0 from the second delay buffer 142 and the pixel data i03 of the first data. Then, the second processing element PE_10 performs a multiplication operation between the weight w0 and the pixel data i03 of the first data and stores the operation value in a register. That is, the value w0*i03 is stored in the register connected to the second processing element PE_10.

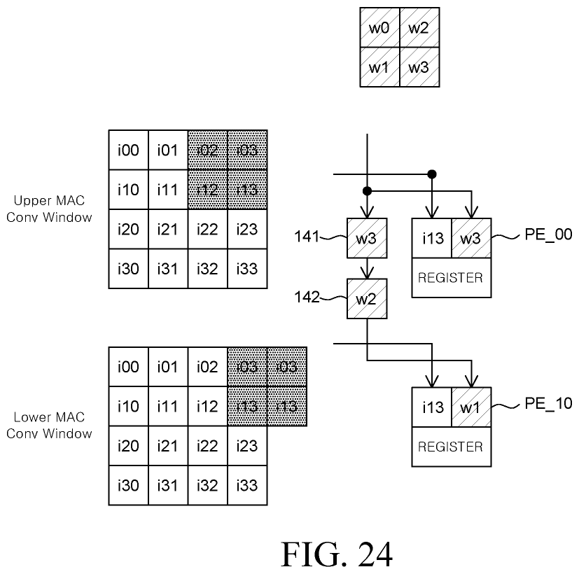

Referring to FIG. 24, during an eighth clock period, the first processing element PE_00 receives the weight w3 and the pixel data i13 of the first data. Then, the first processing element PE_00 performs a multiplication operation between the weight w3 and the pixel data i13 of the first data and stores the operation value in a register. That is, the value of w0*i02+w1*i12+w2*i03+w3*i13 is stored in the register connected to the first processing element PE_00. That is, operation values may be accumulated in a processing element.

Meanwhile, referring to FIG. 24, during the eighth clock period, the weight w3 is also input to the first delay buffer 141 and the first delay buffer 141 stores the weight w3 for the eighth clock period and delays it by one clock cycle.

Then, the weight w2 delayed by one clock cycle from the first delay buffer 141 is input to the second delay buffer 142 and the second delay buffer 142 delays the weight w2 by one additional clock cycle during the eighth clock period. That is, the weight w2 may be delayed by two clock cycles through the first delay buffer 141 and the second delay buffer 142.

Meanwhile, referring to FIG. 24, during the eighth clock period, the second processing element PE_10 receives the weight w1 from the second delay buffer 142 and the pixel data i13 of the first data. Then, the second processing element PE_10 performs a multiplication operation between the weight w1 and the pixel data i13 of the first data and stores the operation value in a register. That is, the value w0*i03+w1*i13 is stored in the register connected to the second processing element PE_10. That is, operation values may be accumulated in a processing element.

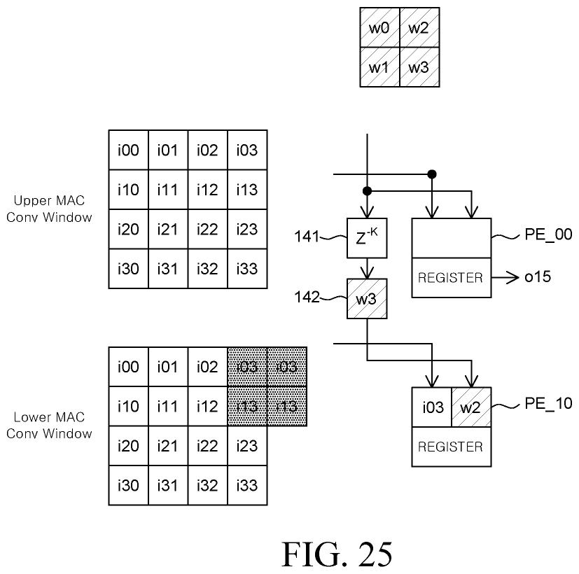

Referring to FIG. 25, during a ninth clock period, the value of w0*i02+w1*i12+w2*i03+w3*i13 stored in the register connected to the first processing element (PE_00) is output as pixel data o15 of the second data.

Then, the weight w3 delayed by one clock cycle from the first delay buffer 141 is input to the second delay buffer 142 and the second delay buffer 142 delays the weight w3 by one additional clock cycle during the ninth clock period. That is, the weight w3 may be delayed by two clock cycles through the first delay buffer 141 and the second delay buffer 142.

Meanwhile, referring to FIG. 25, during the ninth clock period, the second processing element PE_10 receives the weight w2 from the second delay buffer 142 and the pixel data i03 of the first data. Then, the second processing element PE_10 performs a multiplication operation between the weight w2 and the pixel data i03 of the first data and stores the operation value in a register. That is, the value of w0*i03+w1*i13+w2*i03 is stored in the register connected to the second processing element PE_10. That is, operation values may be accumulated in a processing element.

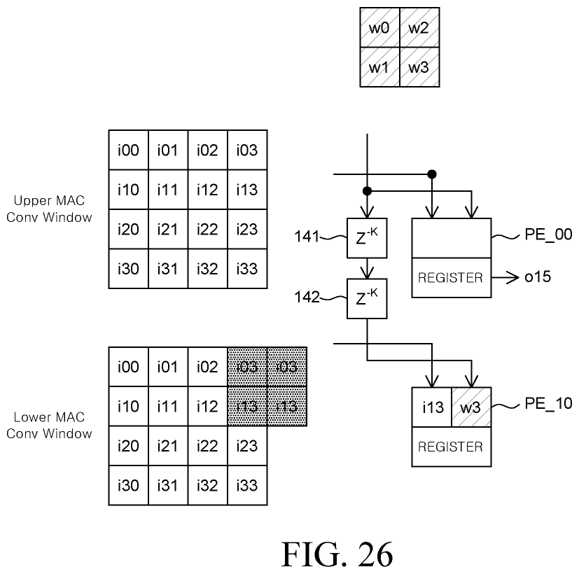

Referring to FIG. 26, during a tenth clock period, the second processing element PE_10 receives the weight w3 from the second delay buffer 142 and the pixel data i13 of the first data. Then, the second processing element PE_10 performs a multiplication operation between the weight w3 and the pixel data i13 of the first data and stores the operation value in a register. That is, the value of w0*i03+w1*i13+w2*i03+w3*i03 is stored in the register connected to the second processing element PE_10. That is, operation values may be accumulated in a processing element.

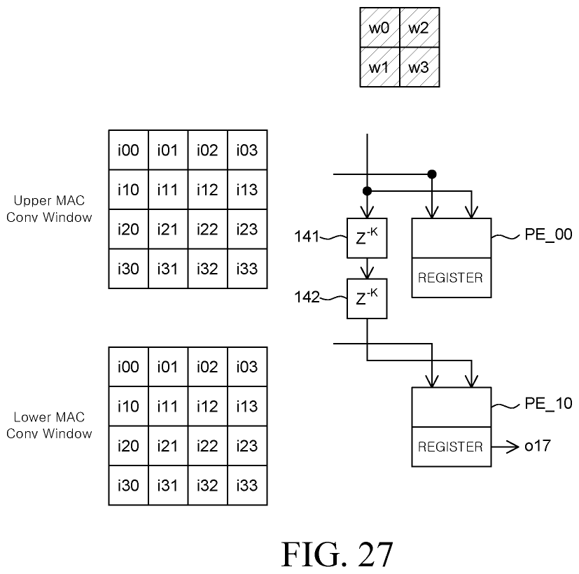

Referring to FIG. 27, during an eleventh clock period, the value of w0*i03+w1*i13+w2*i03+w3*i03 stored in the register connected to the second processing element PE_10 is output as pixel data o17 of the second data.

In this way, the value multiplied by the weight and pixel data may be accumulated in the accumulator of the processing element at every clock cycle.

In this way, the weight may be reused by transferring it to another processing element through the delay buffer. Accordingly, power consumption of the neural processing unit 1000 may be reduced by reusing weights.

In this way, when feature map data (i.e., input feature map data) and weights are input to each processing element, a MAC operation on the feature map data and weights input to each PE is performed every clock cycle. The operation result data (i.e., output feature map data) calculated through the operation may be output from each processing element and input into a decimal multiplier, or may be stored in the internal memory 200 or the feature map storage unit 220.

That is, each processing element receives weight and feature map data and performs a MAC operation on the weight and feature map data.

That is, the processing element array may be configured to include a first processing element PE_00 that receives the weight, and a delay buffer Z -k configured to receive the weight, delay it to a specific clock cycle, and transmit it to the second processing element PE_10. Here, the delay period of the delay buffer may be determined by the value of k. Accordingly, the delay buffer may be configured to process depth-wise convolution while reusing weights.

In other words, by providing one delay buffer that transfers the weight and two processing elements corresponding to the input and output of the delay buffer, it is possible to implement depth-wise convolution that enables data reuse.

That is, according to the above-described configuration, the neural processing unit 1000 can selectively perform a convolution operation and a bilinear interpolation operation of a general artificial neural network model. Accordingly, even though the neural processing unit 1000 does not have a separate circuit for bilinear interpolation calculation, it can effectively perform bilinear interpolation using processing elements. In particular, bilinear interpolation using multiple processing elements is effective in efficiently processing segmentation operations and upscaling operations during artificial neural network operations.

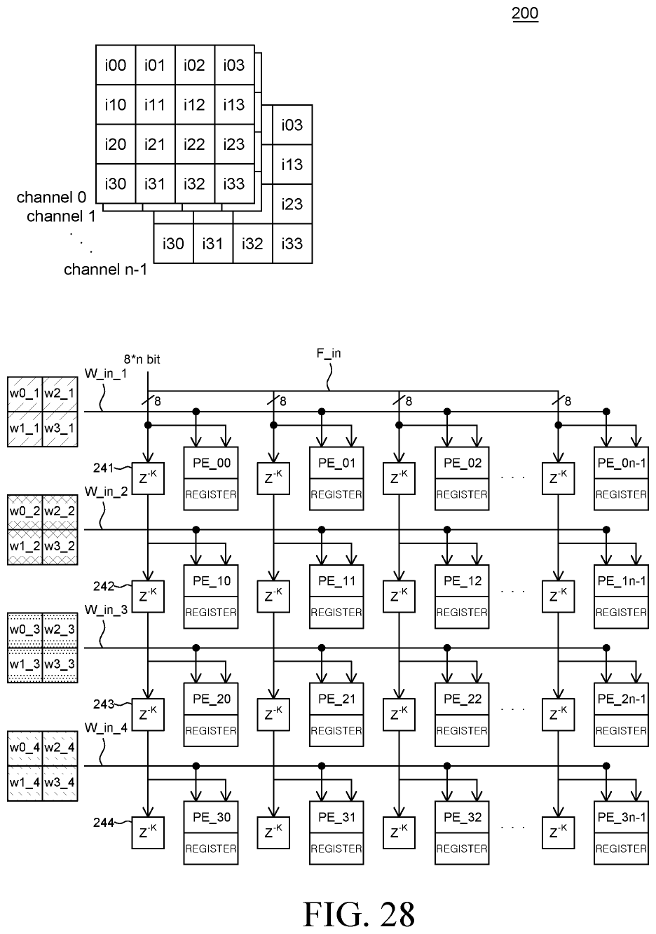

Hereinafter, a method in which the processing element array performs a pointwise convolution operation will be described with reference to FIGS. 28 to 36.

FIG. 28 illustrates the structure of a processing element array according to another example of the present disclosure.

Referring to FIG. 28, the processing element array may include a plurality of PEs consisting of a plurality of PE rows and a plurality of PE columns.

To elaborate, the first PE row may refer to a plurality of processing elements PE_00 through PE_0n−1 arranged in the first row. The second PE row may refer to a plurality of processing elements PE_10 through PE_1n−1 arranged in the second row. The third PE row may refer to a plurality of processing elements PE_20 through PE_2n−1 arranged in the third row. The fourth PE row may refer to a plurality of processing elements PE_30 through PE_3n−1 arranged in the fourth row.

To elaborate, the first PE column may refer to a plurality of processing elements (PE_00, PE_10, . . . ) arranged in the first column. The second PE column may refer to the second plurality of processing elements (PE_01, PE_11, . . . ) arranged in the second column. The third PE column may refer to a plurality of processing elements (PE_02, PE_12, . . . ) arranged in the third column. The n−1th PE column may refer to the nth plurality of processing elements (PE_0n−1, PE_1n−1, . . . ) arranged in the n−1th column.

Referring to FIG. 28, the first PE column PE_00 through PE_0n−1 may be connected to the weight storage unit 210 through the signal line W_in_1 through which the first weights w0_1, w1_1, w2_1, and w3_1 are transmitted. First weights w0_1, w1_1, w2_1, and w3_1 are output from the weight storage unit 210. The first weights w1_1, w2_1, w3_1, and w0_1 are input to the first PE column PE_00 to PE_0n−1 through the branch of the signal line W_in. More specifically, the first weights w0_1, w1_1, w2_1, and w3_1 used in the bilinear interpolation operation for each of the first PE column PE_00 to PE_0n−1 may be broadcasted. That is, the same weight may be input to each of the first PE column PE_00 to PE_0n−1 at the same timing.

In addition, the second PE column PE_10 to PE_1n−1 may be connected to the weight storage unit 210 through the signal line W_in_2 through which the second weights w0_2, w1_2, w2_2, and w3_2 are transmitted. Second weights w0_2, w1_2, w2_2, and w3_2 are output from the weight storage unit 210. The second weights w0_2, w1_2, w2_2, and w3_2 are input to the second PE column PE_10 to PE_1n−1 through the branch of the signal line W_in. More specifically, the second weights w0_2, w1_2, w2_2, and w3_2 used in the bilinear interpolation operation in each of the second PE column PE_10 to PE_1n−1 may be broadcasted. That is, the same weight may be input to each of the second PE column PE_10 to PE_1n−1 at the same timing.

In addition, the third PE column PE_20 to PE_2n−1 may be connected to the weight storage unit 210 through the signal line W_in_3 through which the third weights w0_3, w1_3, w2_3, and w3_3 are transmitted. Third weights w0_3, w1_3, w2_3, and w3_3 are output from the weight storage unit 210. The third weights w0_3, w1_3, w2_3, and w3_3 are input to the third PE column PE_20 to PE_2n−1 through the branch of the signal line W_in. More specifically, the third weights w0_3, w1_3, w2_3, and w3_3 used in the bilinear interpolation operation in each of the third PE column PE_20 to PE_2n−1 may be broadcasted. That is, the same weight may be input to each of the third PE column PE_20 to PE_2n−1 at the same timing.

In addition, the fourth PE column PE_30 to PE_3n−1 may be connected to the weight storage unit 210 through the signal line W_in_4 through which the fourth weights w0_4, w1_4, w2_4, and w3_4 are transmitted. Fourth weights w0_4, w1_4, w2_4, and w3_4 are output from the weight storage unit 210. The fourth weight w0_4, w1_4, w2_4, and w3_4 is input to the fourth PE column PE_30 to PE_3n−1 through the branch of the signal line W_in. More specifically, the fourth weights w0_4, w1_4, w2_4, and w3_4 used in the bilinear interpolation operation in each of the fourth PE column PE_30 to PE_3n−1 may be broadcasted. That is, the same weight may be input to each of the fourth PE column PE_30 to PE_3n−1 at the same timing.

That is, each of the plurality of weights may be configured to be broadcast to processing elements arranged in different rows of the processing element array.

Meanwhile, each of the plurality of PE columns may be connected to the feature map storage unit 220 through a F_in signal line through which feature map data is transmitted. The feature map data output from the feature map storage unit 220 is input to each of the plurality of PE columns through each F_in signal line. For example, n-channels feature map data may be unicasted or broadcasted to each of the first to nth PE columns. The feature map data described above may be pixel data of the first data.

The F_in signal line may be a bus consisting of n channels. The F_in signal line may be a bus line including individual signal lines corresponding to one PE column. For example, if the first PE row (PE_00, PE_01, . . . ) is configured to have 64 processing elements, the F_in signal line may be a bus line composed of 64 lines. Additionally, the F_in signal line may be configured to unicast individual feature map data or broadcast the same feature map data to each processing element of the PE column.

When feature map data and weights are input to each processing element, MAC operations on the feature map data and weights input from each processing element are performed every clock cycle, and operation result data (i.e., feature map data) calculated through the operation may be output from each processing element and stored in the feature map storage unit 220.

To elaborate, it is not illustrated in FIG. 28, but referring to FIG. 13, each processing element may be configured to include an F_out signal line that outputs the MAC operation value from a register where the MAC operation value is stored. However, the present disclosure is not limited thereto, and the F_out signal line may be configured to be connected to the internal memory 200 or another additional calculation unit.

Meanwhile, a plurality of delay buffers 241, 242, 243, and 244 may also be connected to the feature map storage unit 220 through a signal line F_in through which feature map data is transmitted. The feature map data output from the feature map storage unit 220 is input to a plurality of delay buffers 241, 242, 243, and 244 through branches of the signal line F_in through which each feature map data is transmitted.

More specifically, the plurality of delay buffers 241, 242, 243, and 244 may be composed of a first delay buffer 241, a second delay buffer 242, a third delay buffer 243, and a fourth delay buffer 244 connected in series. In this case, the first delay buffer 241 may be connected to the feature map storage unit 220 through a signal line F_in through which feature map data is transmitted. Here, k of the first to fourth delay buffers may be 1. Therefore, each delay buffer can delay data by one clock cycle.

Accordingly, the feature map data is input to the first delay buffer 241. Then, the first delay buffer 241 delays the input feature map data by one clock cycle and outputs it to the second delay buffer 243 and the second PE column. Accordingly, feature map data delayed by one clock cycle by the first delay buffer 241 may be input to the second PE column.

In addition, the second delay buffer 242 delays the input feature map data by one clock cycle and outputs it to the third delay buffer 243 and the third PE column. As a result, feature map data delayed by two clock cycles by the first delay buffer 241 and the second delay buffer 242 may be input to the third PE column.

In addition, the third delay buffer 243 delays the input feature map data by one clock cycle and outputs it to the fourth delay buffer 244 and the fourth PE column. As a result, feature map data delayed by three clock cycles by the first delay buffer 241, the second delay buffer 242, and the third delay buffer 243 may be input to the fourth PE column.

In other words, feature map data delayed and transmitted through the delay buffer Z^{-k} may be delayed broadcasting in each PE column direction. Therefore, the feature map data transmitted from the feature map storage unit 220 may be reused in each processing element where the delayed feature map data is provided by delayed broadcasting. Through this, feature map data may be reused within the processing element array, minimizing resource consumption and memory usage used for calculations.

Additionally, according to the above-described configuration, multiple processing elements may be utilized for bilinear interpolation calculation. Therefore, there is an effect of improving the bilinear interpolation calculation speed.

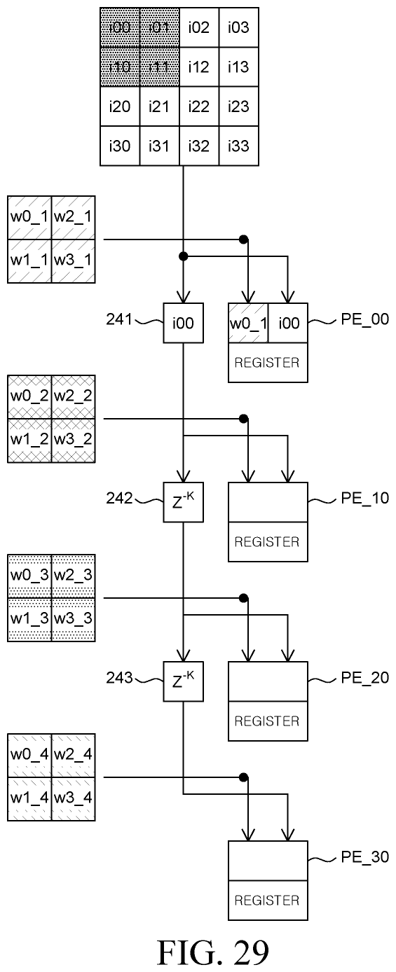

Hereinafter, a method in which the processing element array performs a point-wise convolution operation will be described with reference to FIGS. 29 to 36.

FIGS. 29 to 36 are diagrams for explaining how a processing element array according to an example of the present disclosure operates during a plurality of clock cycles.

FIGS. 29 to 36 illustrate a process in which the first PE column performs convolution on input data of one channel among input data of n channels during a plurality of clock cycles.

Referring to FIG. 29, during the first clock period, the first processing element PE_00 receives the first weight w0_1 and the pixel data i00 of the first data. Then, the first processing element PE_00 performs a multiplication operation between the first weight w0_1 and the pixel data i00 of the first data and stores the operation value in a register. That is, the value w0_1*i00 is stored in the register connected to the first processing element PE_00.

Meanwhile, referring to FIG. 29, pixel data i00 of the first data is also input to the first delay buffer 241 during the first clock period and the first delay buffer 241 stores the pixel data i00 of the first data during the first clock period and delays it by one clock cycle.

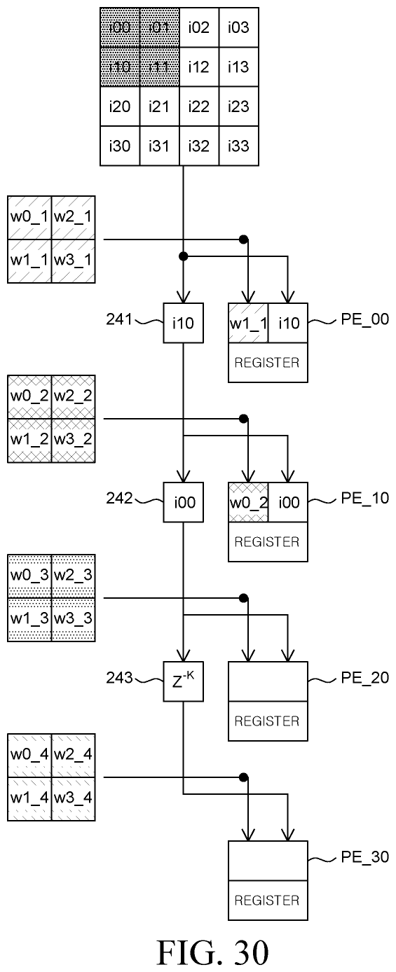

In addition, referring to FIG. 30, during the second clock period, the first processing element PE_00 receives the first weight w1_1 and the pixel data i10 of the first data. Then, the first processing element PE_00 performs a multiplication operation between the first weight w1_1 and the pixel data i10 of the first data and stores the operation value in a register. That is, the value of w0_1*i00+w1_1*i10 is stored in the register connected to the first processing element PE_00. That is, operation values may be accumulated in a processing element.

Meanwhile, referring to FIG. 30, pixel data i10 of the first data is also input to the first delay buffer 241 during the second clock period and the first delay buffer 241 stores the pixel data i10 of the first data during the second clock period and delays it by one clock cycle.

In addition, during the second clock period, the second processing element PE_10 receives pixel data i00 of the first data from the first delay buffer 241 and receives the second weight w0_2. Then, the second processing element PE_10 performs a multiplication operation between the second weight w0_2 and the pixel data i00 of the first data and stores the operation value in a register. That is, the value w0_2*i00 is stored in the register connected to the second processing element PE_10.

In addition, pixel data i00 of the first data delayed by one clock cycle from the first delay buffer 241 is input to the second delay buffer 242. Then, the second delay buffer 242 delays the pixel data i00 of the first data by one additional clock cycle during the second clock period. That is, pixel data i00 of the first data may be delayed by two clock cycles through the first delay buffer 241 and the second delay buffer 242.

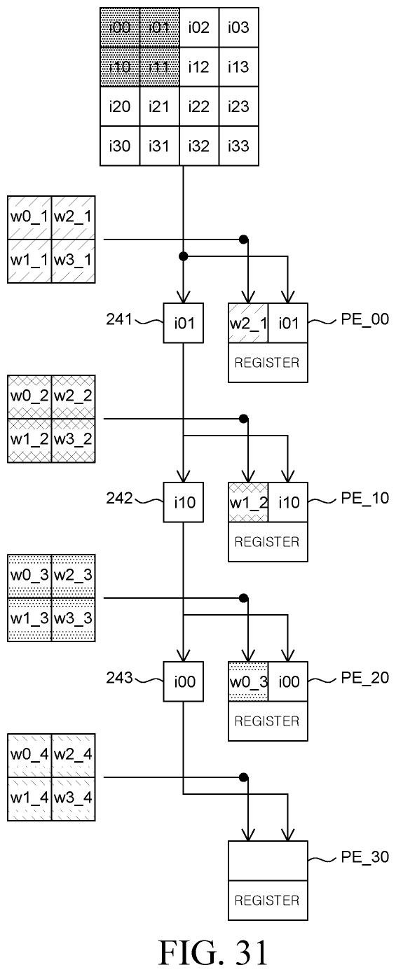

Referring to FIG. 31, during the third clock period, the first processing element PE_00 receives the first weight w2_1 and the pixel data i01 of the first data. Then, the first processing element PE_00 performs a multiplication operation between the first weight w2_1 and the pixel data i01 of the first data and stores the operation value in a register. That is, the value of w0_1*i00+w1_1*i10+w2_1*i01 is stored in the register connected to the first processing element PE_00. That is, operation values may be accumulated in a processing element.

Meanwhile, referring to FIG. 31, pixel data i01 of the first data is also input to the first delay buffer 241 during the third clock period and the first delay buffer 241 stores the pixel data i01 of the first data during the third clock period and delays it by one clock cycle.

In addition, during the third clock period, the second processing element PE_10 receives pixel data i10 of the first data from the first delay buffer 241 and receives the second weight w1_2. Then, the second processing element PE_10 performs a multiplication operation between the second weight w1_2 and the pixel data i10 of the first data and stores the operation value in a register. That is, the value w0_2*i00+w1_2*i10 is stored in the register connected to the second processing element PE_10. That is, operation values may be accumulated in a processing element.

In addition, pixel data i10 of the first data delayed by one clock cycle from the first delay buffer 241 is input to the second delay buffer 242. Additionally, the second delay buffer 242 delays the pixel data i10 of the first data by one additional clock cycle during the third clock period. That is, pixel data i10 of the first data may be delayed by two clock cycles through the first delay buffer 241 and the second delay buffer 242.

In addition, during the third clock period, the third processing element PE_20 receives pixel data i00 of the first data from the second delay buffer 242 and receives the third weight w0_3. Then, the third processing element PE_20 performs a multiplication operation between the third weight w0_3 and the pixel data i00 of the first data and stores the operation value in a register. That is, the value w0_3*i00 is stored in the register connected to the third processing element PE_20.

In addition, pixel data i00 of the first data delayed by two clock cycles from the second delay buffer 242 is input to the third delay buffer 243. Additionally, the third delay buffer 243 delays the pixel data i00 of the first data by an additional clock cycle during the third clock period. That is, pixel data i00 of the first data may be delayed by three clock cycles through the first delay buffer 241, the second delay buffer 242, and the third delay buffer 243.

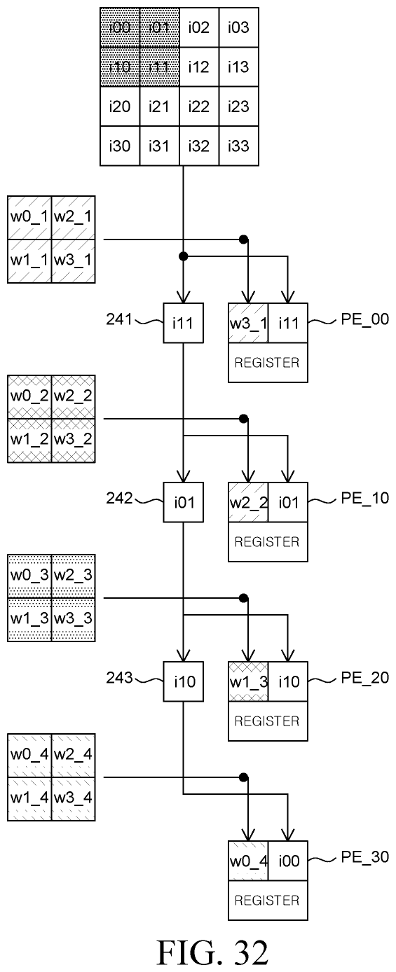

In addition, referring to FIG. 32, during the fourth clock period, the first processing element PE_00 receives the first weight w3_1 and the pixel data i11 of the first data. Then, the first processing element PE_00 performs a multiplication operation between the first weight w3_1 and the pixel data i11 of the first data and stores the operation value in a register. That is, the value of w0_1*i00+w1_1*i10+w2_1*i01+w3_1*i11 is stored in the register connected to the first processing element PE_00. That is, operation values may be accumulated in a processing element.

Meanwhile, referring to FIG. 32, pixel data i11 of the first data is also input to the first delay buffer 241 during the fourth clock period and the first delay buffer 241 stores the pixel data i11 of the first data during the fourth clock period and delays it by one clock cycle.

In addition, during the fourth clock period, the second processing element PE_10 receives pixel data i01 of the first data from the first delay buffer 241 and receives the second weight w2_2. Then, the second processing element PE_10 performs a multiplication operation between the second weight w2_2 and the pixel data i01 of the first data and stores the operation value in a register. That is, the value of w0_2*i00+w1_2*i10+w2_2*i01 is stored in the register connected to the second processing element PE_10. That is, operation values may be accumulated in a processing element.

In addition, pixel data i01 of the first data delayed by one clock cycle from the first delay buffer 241 is input to the second delay buffer 242 and the second delay buffer 242 delays the pixel data i01 of the first data by an additional clock cycle for the fourth clock period. That is, pixel data i01 of the first data may be delayed by two clock cycles through the first delay buffer 241 and the second delay buffer 242.

In addition, during the fourth clock period, the third processing element PE_20 receives pixel data i10 of the first data from the second delay buffer 242 and receives the third weight w1_3. Then, the third processing element PE_20 performs a multiplication operation between the third weight w1_3 and the pixel data i10 of the first data and stores the operation value in a register. That is, the value of w0_3*i00+w1_3*i10 is stored in the register connected to the third processing element PE_20. That is, operation values may be accumulated in a processing element.

In addition, pixel data i10 of the first data delayed by two clock cycles from the second delay buffer 242 is input to the third delay buffer 243. Additionally, the third delay buffer 243 delays the pixel data i10 of the first data by an additional clock cycle during the fourth clock period. That is, pixel data i10 of the first data may be delayed by three clock cycles through the first delay buffer 241, the second delay buffer 242, and the third delay buffer 243.

In addition, during the fourth clock period, the fourth processing element PE_30 receives pixel data i00 of the first data from the third delay buffer 243 and receives the fourth weight w0_4. Then, the fourth processing element PE_30 performs a multiplication operation between the fourth weight w0_4 and the pixel data i00 of the first data and stores the operation value in a register. That is, the value w0_4*i00 is stored in the register connected to the fourth processing element PE_30.

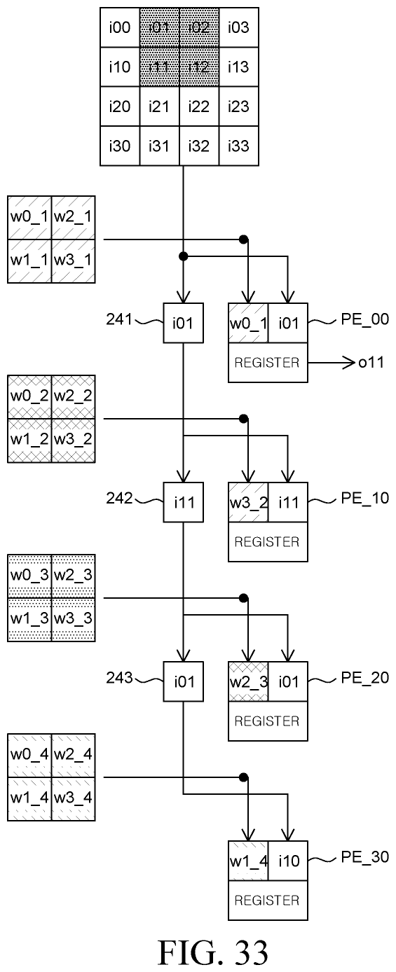

In addition, referring to FIG. 33, the value of w0_1*i00+w1_1*i10+w2_1*i01+w3_1*i11 stored in the register connected to the first processing element PE_00 during the fifth clock period is output as pixel data o11 of the second data.

In addition, referring to FIG. 33, during the fifth clock period, the first processing element PE_00 receives the first weight w0_1 and the pixel data i01 of the first data. Then, the first processing element PE_00 performs a multiplication operation between the first weight w0_1 and the pixel data i01 of the first data and stores the operation value in a register. That is, the value w0_1*i01 is stored in the register connected to the first processing element PE_00.

Meanwhile, referring to FIG. 33, pixel data i01 of the first data is also input to the first delay buffer 241 during the fifth clock period and the first delay buffer 241 stores the pixel data i01 of the first data for the fifth clock period and delays it by one clock cycle.

In addition, during the fifth clock period, the second processing element PE_10 receives pixel data i11 of the first data from the first delay buffer 241 and receives the second weight w3_2. Then, the second processing element PE_10 performs a multiplication operation between the second weight w3_2 and the pixel data i11 of the first data and stores the operation value in a register. That is, the value of w0_2*i00+w1_2*i10+w2_2*i01+w3_2*i11 is stored in the register connected to the second processing element PE_10. That is, operation values may be accumulated in a processing element.

In addition, pixel data i11 of the first data delayed by one clock cycle from the first delay buffer 241 is input to the second delay buffer 242. Additionally, the second delay buffer 242 delays the pixel data i11 of the first data by an additional clock cycle for the fifth clock period. That is, pixel data i11 of the first data may be delayed by two clock cycles through the first delay buffer 241 and the second delay buffer 242.

In addition, during the fifth clock period, the third processing element PE_20 receives pixel data i01 of the first data from the second delay buffer 242 and receives the third weight w2_3. Then, the third processing element PE_20 performs a multiplication operation between the third weight w2_3 and the pixel data i01 of the first data and stores the operation value in a register. That is, values of w0_3*i00+w1_3*i10+w2_3*i01 are stored in the register connected to the third processing element PE_20. That is, operation values may be accumulated in a processing element.

In addition, pixel data i01 of the first data delayed by two clock cycles from the second delay buffer 242 is input to the third delay buffer 243. Additionally, the third delay buffer 243 delays the pixel data i01 of the first data by an additional clock cycle for the fifth clock period. That is, pixel data i01 of the first data may be delayed by three clock cycles through the first delay buffer 241, the second delay buffer 242, and the third delay buffer 243.

In addition, during the fifth clock period, the fourth processing element PE_30 receives pixel data i10 of the first data from the third delay buffer 243 and receives the fourth weight w1_4. Then, the fourth processing element PE_30 performs a multiplication operation between the fourth weight w1_4 and the pixel data i10 of the first data and stores the operation value in a register. That is, values w0_4*i00+w1_4*i10 are stored in the register connected to the fourth processing element PE_30. That is, operation values may be accumulated in a processing element.

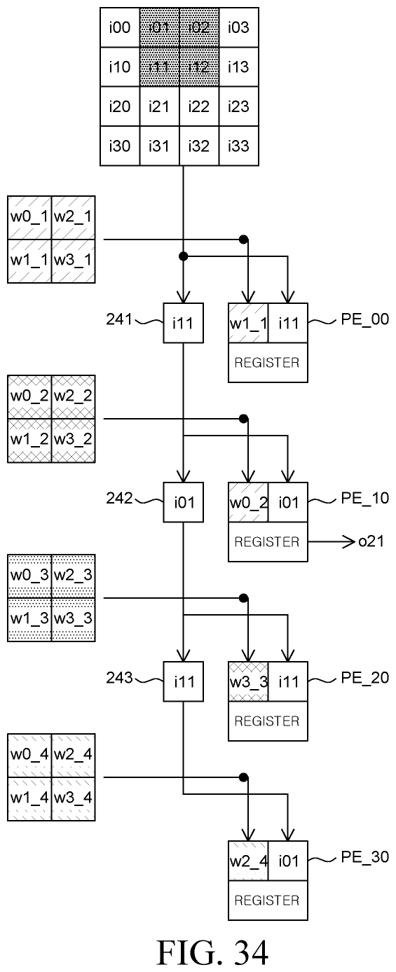

In addition, referring to FIG. 34, during the sixth clock period, the first processing element PE_00 receives the first weight w1_1 and the pixel data i11 of the first data. Then, the first processing element PE_00 performs a multiplication operation between the first weight w1_1 and the pixel data i11 of the first data and stores the operation value in a register. That is, values w0_1*i01+w1_1*i11 are stored in the register connected to the first processing element PE_00. That is, operation values may be accumulated in a processing element.

Meanwhile, referring to FIG. 34, pixel data i11 of the first data is also input to the first delay buffer 241 during the sixth clock period and the first delay buffer 241 stores the pixel data i11 of the first data for the sixth clock period and delays it by one clock cycle.

In addition, referring to FIG. 34, the value of w0_2*i00+w1_2*i10+w2_2*i01+w3_2*i11 stored in the register connected to the second processing element PE_10 during the sixth clock period is output as pixel data o21 of the second data.

In addition, during the sixth clock period, the second processing element PE_10 receives pixel data i01 of the first data from the first delay buffer 241 and receives the second weight w0_2. Then, the second processing element PE_10 performs a multiplication operation between the second weight w0_2 and the pixel data i01 of the first data and stores the operation value in a register. That is, the value w0_2*i01 is stored in the register connected to the second processing element PE_10.

In addition, pixel data i01 of the first data delayed by one clock cycle from the first delay buffer 241 is input to the second delay buffer 242. Additionally, the second delay buffer 242 delays the pixel data i01 of the first data by an additional clock cycle for the sixth clock period. That is, pixel data i01 of the first data may be delayed by two clock cycles through the first delay buffer 241 and the second delay buffer 242.

In addition, during the sixth clock period, the third processing element PE_20 receives pixel data i11 of the first data from the second delay buffer 242 and receives the third weight w3_3. Then, the third processing element PE_20 performs a multiplication operation between the third weight w3_3 and the pixel data i11 of the first data and stores the operation value in a register. That is, values of w0_3*i00+w1_3*i10+w2_3*i01+w3_3*i11 are stored in the register connected to the third processing element PE_20. That is, operation values may be accumulated in a processing element.

In addition, pixel data i11 of the first data delayed by two clock cycles from the second delay buffer 242 is input to the third delay buffer 243. Additionally, the third delay buffer 243 delays the pixel data i11 of the first data by one additional clock cycle during the sixth clock period. That is, pixel data ill of the first data may be delayed by three clock cycles through the first delay buffer 241, the second delay buffer 242, and the third delay buffer 243.

In addition, during the sixth clock period, the fourth processing element PE_30 receives pixel data i01 of the first data from the third delay buffer 243 and receives the fourth weight w2_4. Then, the fourth processing element PE_30 performs a multiplication operation between the fourth weight w2_4 and the pixel data i01 of the first data and stores the operation value in a register. That is, values of w0_4*i00+w1_4*i10+w2_4*i01 are stored in the register connected to the fourth processing element PE_30. That is, operation values may be accumulated in a processing element.

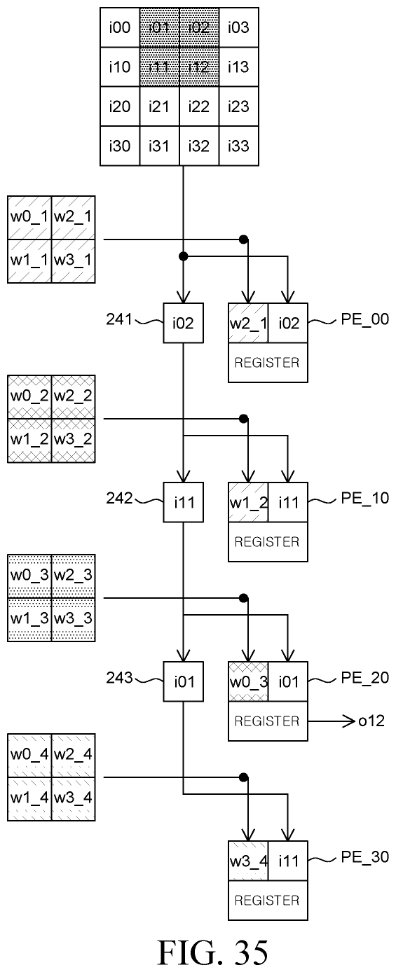

In addition, referring to FIG. 35, during the seventh clock period, the first processing element PE_00 receives the first weight w2_1 and the pixel data i02 of the first data. Then, the first processing element PE_00 performs a multiplication operation between the first weight w2_1 and the pixel data i02 of the first data and stores the operation value in a register. That is, values of w0_1*i01+w1_1*i11+w2_1*i02 are stored in the register connected to the first processing element PE_00. That is, operation values may be accumulated in a processing element.

Meanwhile, referring to FIG. 35, pixel data i02 of the first data is also input to the first delay buffer 241 during the seventh clock period and the first delay buffer 241 stores pixel data i02 of the first data for the seventh clock period and delays it by one clock cycle.

In addition, during the seventh clock period, the second processing element PE_10 receives pixel data i11 of the first data from the first delay buffer 241 and receives the second weight w1_2. Then, the second processing element PE_10 performs a multiplication operation between the second weight w1_2 and the pixel data i11 of the first data and stores the operation value in a register. That is, values of w0_2*i01+w1_2*i11 are stored in the register connected to the second processing element PE_10. That is, operation values may be accumulated in a processing element.

In addition, pixel data i11 of the first data delayed by one clock cycle from the first delay buffer 241 is input to the second delay buffer 242 and the second delay buffer 242 delays the pixel data i11 of the first data by an additional clock cycle for the seventh clock period. That is, pixel data i11 of the first data may be delayed by two clock cycles through the first delay buffer 241 and the second delay buffer 242.

In addition, referring to FIG. 35, values of w0_3*i00+w1_3*i10+w2_3*i01+w3_3*i11 stored in the register connected to the third processing element PE_20 during the seventh clock period is output as pixel data o12 of the second data.

In addition, during the seventh clock period, the third processing element PE_20 receives pixel data i01 of the first data from the second delay buffer 242 and receives the third weight w0_3. Then, the third processing element PE_20 performs a multiplication operation between the third weight w0_3 and the pixel data i01 of the first data and stores the operation value in a register. That is, the value w0_3*i01 is stored in the register connected to the third processing element PE_20.

In addition, pixel data i01 of the first data delayed by two clock cycles from the second delay buffer 242 is input to the third delay buffer 243. Additionally, the third delay buffer 243 delays the pixel data i01 of the first data by one additional clock cycle during the seventh clock period. That is, pixel data i01 of the first data may be delayed by three clock cycles through the first delay buffer 241, the second delay buffer 242, and the third delay buffer 243.

In addition, during the seventh clock period, the fourth processing element PE_30 receives pixel data i11 of the first data from the third delay buffer 243 and receives the fourth weight w3_4. Then, the fourth processing element PE_30 performs a multiplication operation between the fourth weight w3_4 and the pixel data i11 of the first data and stores the operation value in a register. That is, values of w0_4*i00+w1_4*i10+w2_4*i01+w3_4*i11 are stored in the register connected to the fourth processing element PE_30. That is, operation values may be accumulated in a processing element.

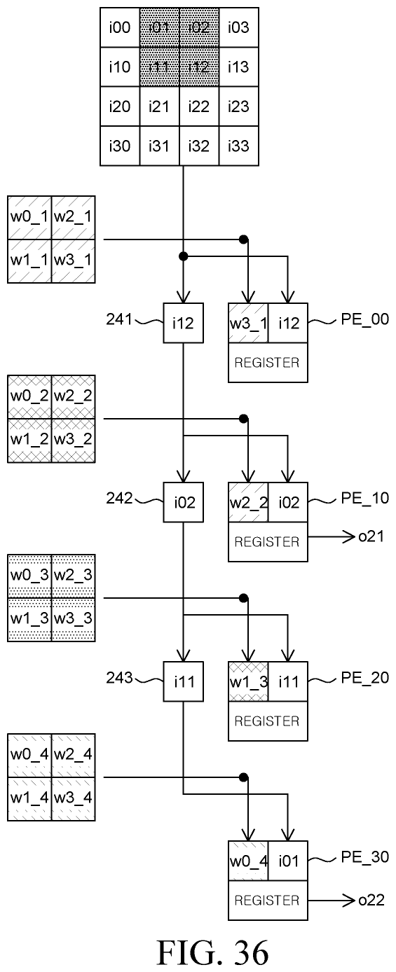

In addition, referring to FIG. 36, during the eighth clock period, the first processing element PE_00 receives the first weight w3_1 and the pixel data i12 of the first data. Then, the first processing element PE_00 performs a multiplication operation between the first weight w3_1 and the pixel data i12 of the first data and stores the operation value in a register. That is, values of w0_1*i01+w1_1*i11+w2_1*i02+w3_1*i12 are stored in the register connected to the first processing element PE_00. That is, operation values can be accumulated in processing elements.

Meanwhile, referring to FIG. 36, pixel data i12 of the first data is also input to the first delay buffer 241 during the eighth clock period and the first delay buffer 241 stores the pixel data i12 of the first data for the eighth clock period and delays it by one clock cycle.

In addition, during the eighth clock period, the second processing element PE_10 receives pixel data i02 of the first data from the first delay buffer 241 and receives the second weight w2_2. Then, the second processing element PE_10 performs a multiplication operation between the second weight w2_2 and the pixel data i02 of the first data and stores the operation value in a register. That is, values of w0_2*i01+w1_2*i11+w2_2*i02 are stored in the register connected to the second processing element PE_10. That is, operation values may be accumulated in a processing element.

In addition, pixel data i02 of the first data delayed by one clock cycle from the first delay buffer 241 is input to the second delay buffer 242. Additionally, the second delay buffer 242 delays the pixel data i02 of the first data by an additional clock cycle for the eighth clock period. That is, pixel data i02 of the first data may be delayed by two clock cycles through the first delay buffer 241 and the second delay buffer 242.

In addition, during the eighth clock period, the third processing element PE_20 receives pixel data i11 of the first data from the second delay buffer 242 and receives the third weight w1_3. Then, the third processing element PE_20 performs a multiplication operation between the third weight w1_3 and the pixel data i11 of the first data and stores the operation value in a register. That is, values of w0_3*i01+w1_3*i11 are stored in the register connected to the third processing element PE_20. That is, operation values may be accumulated in a processing element.

In addition, pixel data i11 of the first data delayed by two clock cycles from the second delay buffer 242 is input to the third delay buffer 243. Additionally, the third delay buffer 243 delays the pixel data i11 of the first data by one additional clock cycle during the eighth clock period. That is, pixel data i11 of the first data may be delayed by three clock cycles through the first delay buffer 241, the second delay buffer 242, and the third delay buffer 243.

In addition, referring to FIG. 36, the w0_4*i00+w1_4*i10+w2_4*i01+w3_4*i11 value stored in the register connected to the fourth processing element PE_30 during the eighth clock period is output as pixel data o22 of the second data.

In addition, during the eighth clock period, the fourth processing element PE_30 receives pixel data i01 of the first data from the third delay buffer 243 and receives the fourth weight w0_4. Then, the fourth processing element PE_30 performs a multiplication operation between the fourth weight w0_4 and the pixel data i01 of the first data and stores the operation value in a register. That is, w0_4*i01 is stored in the register connected to the fourth processing element PE_30.

In this way, the value multiplied by the weight and pixel data may be accumulated in the accumulator of the processing element at every clock cycle.

In this way, the weight can be reused by transferring it to another processing element through the delay buffer. Accordingly, power consumption of the neural processing unit 1000 can be reduced by reusing weights.

In this way, when feature map data (i.e., input feature map data) and weights are input to each processing element, a MAC operation on the feature map data and weights input to each processing element is performed every clock. The operation result data (i.e., output feature map data) calculated through the operation may be output from each processing element and stored in the internal memory 200 or the feature map storage unit 220.

That is, each processing element receives weight and feature map data and performs a MAC operation on the weight and feature map data.

In other words, the processing element array may be configured to include a first processing element PE_00 that receives feature map data, and a delay buffer Z^{-k} configured to receive feature map data, delay it to a specific clock cycle, and transmit it to the second processing element PE_10. Here, the delay period of the delay buffer can be determined by the value of k. Accordingly, the delay buffer can be configured to process point-wise convolution while reusing feature map data.

In other words, by providing one delay buffer that transmits feature map data and two processing elements corresponding to the input and output of the delay buffer, it is possible to implement point-wise convolution that enables data reuse.

Meanwhile, as shown in FIGS. 17 to 27, when performing a depth-wise convolution operation to increase resolution, the NPU performs the operation using only two PE rows of the processing element array composed of a plurality of PE matrices, so there are PEs that are not used for the operation. Accordingly, the utilization rate of the processing element array that performs the depth-wise convolution operation may decrease. However, when the operation rate of the processing element array decreases, the power consumption of the neural processing unit 1000 can be reduced. Accordingly, the neural processing unit 1000 may operate to perform bilinear interpolation using depth-wise convolution when prioritizing power consumption.

In contrast, as shown in FIGS. 17 to 27, when performing a point-wise convolution operation to increase resolution, since the NPU performs calculations using a larger number of PE rows (e.g., four PE rows), the utilization rate of the processing element array can be increased. Accordingly, the neural processing unit 1000 may operate to perform bilinear interpolation with point-wise convolution when prioritizing processing speed.

Accordingly, the computational speed of the neural processing unit according to another example of the present disclosure may be improved

According to the present disclosure, a neural processing unit may include a processing element array (PE Array) including a plurality of processing elements (PEs) that perform bilinear interpolation to generate second data by expanding the resolution of the first data.

A plurality of pixel data of the second data may be obtained by performing a convolution operation with a plurality of weights corresponding to bilinear interpolation with respect to a plurality of pixel data of the first data.

Each element of the plurality of weights may be a coefficient that is input to at least one processing element and multiplied by the plurality of pixel data of the first data to perform bilinear interpolation.

A plurality of pixels of the second data generated by performing bilinear interpolation may be arranged between a plurality of pixels of the first data.

In order to calculate the plurality of pixel data of the second data disposed outside the first data, the outermost plurality of pixel data of the first data may be copied to the outside of the second data.

The neural processing unit may be connected to the output of the PE Array and may further include a floating-point multiplier that performs decimal arithmetic.

The PE Array may be configured to perform depth-wise convolution.

The neural processing unit may further include a plurality of delay buffers connected in series to delay and output the plurality of weights by a specific clock signals.

The plurality of weights may be configured to be broadcast to PEs arranged in the first row of the PE Array and the plurality of delay buffers.

The weight delayed by the plurality of delay buffers is output to PEs arranged in the second row of the PE Array, and the weight may be configured to be reused.

The PE Array may be configured to perform point-wise convolution.

Each of the plurality of weights may be configured to be broadcast to PEs arranged in different rows of the PE Array.

The neural processing unit may further include a plurality of delay buffers connected in series that delay the pixel data of the first data by a specific clock signals and output it.

The plurality of pixel data of the first data may be configured to be cast to PEs arranged in the first row of the PE Array and the plurality of delay buffers.

The plurality of pixel data of the first data delayed by the plurality of delay buffers may be output to PEs arranged in the next row of the PE Array, and the plurality of pixel data of the first data may be reused.

The examples illustrated in the specification and the drawings are merely provided to facilitate the description of the subject matter of the present disclosure and to provide specific examples to aid the understanding of the present disclosure and it is not intended to limit the scope of the present disclosure. It is apparent to those of ordinary skill in the art to which the present disclosure pertains in which other modifications based on the technical spirit of the present disclosure may be implemented in addition to the examples disclosed herein.
[National R&D project supporting this invention]
[Project identification number] 1711175834
[Task number] R-20210401-010439
[Name of ministry] Ministry of Science and ICT
[Name of task management (specialized) institution] Institute of Information & Communications Technology Planning & Evaluation
[Research project title] Intensive Fostering of Innovative Artificial Intelligence Semiconductor Companies
[Research task name] Development of Compilers and Runtime Software Technology for Edge Artificial Neural Network Processors
[Contribution rate] 1/1
[Name of organization performing task] DeepX Co., Ltd.
[Research period] 2022 Jun. 1˜2023 Feb. 28.

What is claimed is:

1. A neural processing unit comprising:
a plurality of processing elements (PEs) configured to perform bilinear interpolation to generate second data by expanding resolution of first data,
wherein the first data includes first pixel data, and
wherein the second data includes second pixel data.

2. The neural processing unit of claim 1, wherein the plurality of PEs include at least one PE configured to receive the first pixel data and a weight for performing the bilinear interpolation and to calculate the second pixel data.

3. The neural processing unit of claim 1, wherein the plurality of PEs include at least one PE configured to receive a 2×2 weight for the bilinear interpolation.

4. The neural processing unit of claim 1,
wherein the plurality of PEs are further configured such that a weight is inputted to each PE of the plurality of PEs, and
wherein the weight is a coefficient that is multiplied by the first pixel data to perform the bilinear interpolation.

5. The neural processing unit of claim 1, wherein the second data includes at least one pixel positioned between a plurality of adjacent pixels of the first data.

6. The neural processing unit of claim 1,
wherein the plurality of PEs include at least one PE configured to duplicate a pixel of the first pixel data corresponding to an outermost area of the first data to be copied to an outer area of the first data, and
wherein the duplication by the at least one processing element generates a pixel of the second pixel data corresponding to an outermost area of the second data.

7. The neural processing unit of claim 1, further comprising a floating-point multiplier connected to an output of the plurality of PEs and configured to perform decimal operations.

8. The neural processing unit of claim 1, wherein the plurality of PEs are further configured to perform a depth-wise convolution.

9. The neural processing unit of claim 1,
wherein the plurality of PEs include a PE array arranged in rows and columns, and
wherein the PE array includes a delay buffer that delays a weight for performing the bilinear interpolation by a number of clock cycles and transmits the weight to an adjacent PE of the PE array.

10. The neural processing unit of claim 1,
wherein the plurality of PEs include a PE array arranged in rows and columns, the PE array including at least one delay buffer, and
wherein the PE array is configured such that a weight for performing the bilinear interpolation is broadcast to PEs of a specific row of the PE array and to a corresponding delay buffer of the at least one delay buffer.

11. The neural processing unit of claim 1,
wherein the plurality of PEs include
a PE array arranged in plural rows and plural columns, and
a delay buffer corresponding to adjacent rows of the PE array, the delay buffer being disposed between the adjacent rows, and
wherein the delay buffer is configured to reuse weights by transferring, in a next clock cycle, a weight input to a PE of a first row of the plural rows to a PE of a second row of the plural rows.

12. The neural processing unit of claim 1, wherein the plurality of PEs are further configured to perform a point-wise convolution.

13. The neural processing unit of claim 1,
wherein the plurality of PEs include a PE array arranged in rows and columns, and
wherein the bilinear interpolation is performed using a plurality of weights, each weight of the plurality of weights being broadcast to a different row of the PE array.

14. The neural processing unit of claim 1, wherein the plurality of PEs include
a PE array arranged in rows and columns, and
a plurality of delay buffers connected in series to delay and output the first pixel data to a specific clock cycle.

15. The neural processing unit of claim 1,
wherein the plurality of PEs include a PE array arranged in plural rows and plural columns, the PE array including a plurality of delay buffers, and
wherein the first pixel data is broadcast to PEs of a first row of the plural rows and to the plurality of delay buffers.

16. The neural processing unit of claim 1,
wherein the plurality of PEs include a PE array that includes a delay buffer,
wherein the first pixel data is inputted to a PE of a row of the PE array and is delayed by the delay buffer, and
wherein the delayed first pixel data is reused in another PE of a next row of the PE array.

17. The neural processing unit of claim 1,
wherein the first data is input data of a specific layer of an artificial neural network model,
wherein the second data is output data of the specific layer, and
wherein the second data is a result of applying the bilinear interpolation to the first data by applying a weight for performing the bilinear interpolation in a specific PE of the plurality of PEs.

18. The neural processing unit of claim 1,
wherein the first data is one of an image, a feature map, and an activation map,
wherein the first data is input data of a specific layer of an artificial neural network model to which the bilinear interpolation is applied, and
wherein the second data is output data of the specific layer.

19. The neural processing unit of claim 1, wherein the plurality of PEs include a multiplier, an adder, and an accumulator.

20. The neural processing unit of claim 1, wherein the plurality of PEs are further configured such that the bilinear interpolation performs an upscaling operation or segmentation operation of an artificial neural network model to which the bilinear interpolation is applied.
